(19) United States
(12) Patent Application Publication
(10) Pub. No.: US 2024/0260060 A1
(43) Pub. Date: Aug. 1, 2024

(54) TECHNIQUES FOR SIDELINK USER EQUIPMENT COORDINATION

(71) Applicant: QUALCOMM INCORPORATED, San Diego, CA (US)

(72) Inventors: Shuanshuan Wu, San Diego, CA (US); Tien Viet Nguyen, Bridgewater, NJ (US); Kapil Gulati, Belle Mead, NJ (US); Sourjya Dutta, San Diego, CA (US); Gabi Sarkis, San Diego, CA (US); Hui Guo, Beijing (CN)

(21) Appl. No.: 18/561,142

(22) PCT Filed: Jul. 30, 2021
(86) PCT No.: PCT/CN2021/109639

§ 371 Date: Nov. 15, 2023

(51) Int. Cl. H04W 72/25; H04L 5/00; H04W 72/02; H04W 72/563

(52) U.S. Cl. CPC H04W 72/25; H04L 5/0048; H04W 72/02; H04W 72/563

(57) ABSTRACT

Methods, systems, and devices for wireless communications are described. To improve sidelink reservation schemes. a first user equipment (UE) may indicate its preferences for sidelink resources to a second UE that may select sidelink resources for sidelink messages based on the indicated preferences. For example, the first UE may monitor a first set of sidelink resources for sidelink control information (SCI) to determine which sidelink resources of a second set of sidelink resources are available. Based on the monitoring, the first UE may generate a bitmap that indicates the first UE's preferences for the sidelink resources of the second set and may transmit a coordination message to the second UE that includes the bitmap. The second UE may receive the coordination message and transmit, to the first UE, one or more sidelink messages using one or more sidelink resources of the second set selected based on the indicated preferences.

### CROSS REFERENCE

The present Application is a 371 national stage filing of International PCT Application No. PCT/CN2021/109639 by Wu et al. entitled “TECHNIQUES FOR SIDELINK USER EQUIPMENT COORDINATION,” filed Jul. 30, 2021, which is assigned to the assignee hereof, and which is expressly incorporated by reference in its entirety herein.

### FIELD OF TECHNOLOGY

The following relates to wireless communications, including techniques for sidelink user equipment (UE) coordination.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple -access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

Some wireless communications systems may support sidelink communications between UEs. In some examples, a UE may receive sidelink control information (SCI) from other UEs to determine which sidelink resources of a set of sidelink resources are reserved and may transmit SCI to reserve available sidelink resources of the set for its own sidelink transmissions. In some cases, however, the UE may fail to receive one or more SCI transmissions and may thus be unaware of corresponding sidelink resource reservations. As a result, the UE may reserve and transmit on sidelink resources that are reserved by other UEs, thereby causing collisions and reducing the reliability of sidelink communications.

### SUMMARY

The described techniques relate to improved methods, systems, devices, and apparatuses that support techniques for sidelink user equipment (UE) coordination. Generally, the described techniques provide for improving sidelink resource reservation and selection schemes by indicating UE preferences for sidelink resources. For example, a first UE may monitor a first set of sidelink resources for sidelink control information (SCI) to determine which sidelink resources of a second set of sidelink resources are available and which sidelink resources are reserved (e.g., unavailable). Based on the monitoring, the first UE may determine whether a given sidelink resource of the second set of sidelink resources is preferred or non-preferred. For example, if the first UE determines that a sidelink resource is available (e.g., based on a reference signal received power (RSRP) of an associated SCI message, based on a priority level associated with the sidelink resource, or both), the first UE may determine that the sidelink resource is a preferred sidelink resource for receiving a sidelink message at the first UE. Alternatively, the first UE may determine that the sidelink resource is a non-preferred sidelink resource for receiving the sidelink message at the first UE if the sidelink resource is reserved.

The first UE may generate a bitmap associated with the second set of sidelink resources that indicates preferences of the first UE for the sidelink resources of the second set of sidelink resources. For example, each bit of the bitmap may correspond to a respective sidelink resource of the second set of sidelink resources and may indicate a respective preference (e.g., preferred or non-preferred) for the respective sidelink resource. The first UE may transmit a coordination message to a second UE that includes the bitmap. Based on the preferences indicated by the bitmap, the second UE may select one or more sidelink resources of the second set of sidelink resources (e.g., one or more preferred sidelink resources) and may transmit one or more sidelink messages (e.g., to the first UE) using the selected one or more sidelink resources.

A method for wireless communication at a first UE is described. The method may include monitoring a first set of sidelink resources for SCI from one or more UEs, generating, based on the monitoring, a bitmap associated with a second set of sidelink resources, where the bitmap indicates a preference of the first UE for a sidelink resource of the second set of sidelink resources, and transmitting, to a second UE, a coordination message including the bitmap.

An apparatus for wireless communication at a first UE is described. The apparatus may include a processor, memory coupled with the processor, and instructions stored in the memory. The instructions may be executable by the processor to cause the apparatus to monitor a first set of sidelink resources for SCI from one or more UEs, generate, based on the monitoring, a bitmap associated with a second set of sidelink resources, where the bitmap indicates a preference of the first UE for a sidelink resource of the second set of sidelink resources, and transmit, to a second UE, a coordination message including the bitmap.

Another apparatus for wireless communication at a first UE is described. The apparatus may include means for monitoring a first set of sidelink resources for SCI from one or more UEs, means for generating, based on the monitoring, a bitmap associated with a second set of sidelink resources, where the bitmap indicates a preference of the first UE for a sidelink resource of the second set of sidelink resources, and means for transmitting, to a second UE, a coordination message including the bitmap.

A non-transitory computer-readable medium storing code for wireless communication at a first UE is described. The code may include instructions executable by a processor to monitor a first set of sidelink resources for SCI from one or more UEs, generate, based on the monitoring, a bitmap associated with a second set of sidelink resources, where the bitmap indicates a preference of the first UE for a sidelink resource of the second set of sidelink resources, and transmit, to a second UE, a coordination message including the bitmap.

Some examples of the method, apparatuses, and non-transitory computer-readable medium described herein may further include operations, features, means, or instructions for receiving the SCI from the one or more UEs based on the monitoring, where the SCI may be associated with a subset of the second set of sidelink resources and measuring an RSRP associated with the SCI, where generating the bitmap may be based on the RSRP.

Some examples of the method, apparatuses, and non-transitory computer-readable medium described herein may further include operations, features, means, or instructions for determining the preference of the first UE for the sidelink resource based on the RSRP and a threshold RSRP.

In some examples of the method, apparatuses, and non-transitory computer-readable medium described herein, the threshold RSRP may be a pre-configured threshold at the first UE and the second UE, configured by a network, common to the first UE and the second UE, or a combination thereof.

Some examples of the method, apparatuses, and non-transitory computer-readable medium described herein may further include operations, features, means, or instructions for receiving, from the second UE, an indication of the threshold RSRP, where determining the preference of the first UE for the sidelink resource may be based on the indication.

Some examples of the method, apparatuses, and non-transitory computer-readable medium described herein may further include operations, features, means, or instructions for determining a priority level associated with a transmission of the second UE associated with the second set of sidelink resources and determining the threshold RSRP from a set of threshold RSRPs corresponding to a set of priority levels including the priority level, the threshold RSRP corresponding to the priority level.

Some examples of the method, apparatuses, and non-transitory computer-readable medium described herein may further include operations, features, means, or instructions for determining the threshold RSRP such that an RSRP associated with at least a threshold percentage of the second set of sidelink resources satisfy the threshold RSRP.

Some examples of the method, apparatuses, and non-transitory computer-readable medium described herein may further include operations, features, means, or instructions for determining a priority level associated with the sidelink resource of the second set of sidelink resources, where the preference of the first UE for the sidelink resource may be based on whether the priority level satisfies a priority threshold associated with the second set of sidelink resources.

In some examples of the method, apparatuses, and non-transitory computer-readable medium described herein, the priority threshold may be a pre-configured priority threshold at the first UE and the second UE, configured by a network, common to the first UE and the second UE, or a combination thereof.

Some examples of the method, apparatuses, and non-transitory computer-readable medium described herein may further include operations, features, means, or instructions for receiving, from the second UE, an indication of the priority threshold associated with the second set of sidelink resources, where determining the priority level may be based on the indication of the priority threshold.

Some examples of the method, apparatuses, and non-transitory computer-readable medium described herein may further include operations, features, means, or instructions for determining the priority threshold such that a priority level corresponding to a threshold percentage of the second set of sidelink resources satisfy the priority threshold.

Some examples of the method, apparatuses, and non-transitory computer-readable medium described herein may further include operations, features, means, or instructions for generating a set of bitmaps associated with the second set of sidelink resources, each bitmap of the set of bitmaps corresponding to a respective priority threshold of a set of priority thresholds, where the coordination message includes the set of bitmaps.

In some examples of the method, apparatuses, and non-transitory computer-readable medium described herein, the coordination message further includes a first indication of a priority threshold used to generate the bitmap, a second indication of a threshold RSRP used to generate the bitmap, a third indication of whether the preference of the first UE may be associated with a preferred sidelink resource or a non-preferred sidelink resource, or a combination thereof.

In some examples of the method, apparatuses, and non-transitory computer-readable medium described herein, each bit of the bitmap corresponds to a respective sidelink resource of the second set of sidelink resources, each bit indicates a respective preference of the first UE for the respective sidelink resource, and the coordination message includes an SCI message, a media access control (MAC)-CE message, a radio resource control (RRC) message, or a combination thereof.

Some examples of the method, apparatuses, and non-transitory computer-readable medium described herein may further include operations, features, means, or instructions for receiving, from the second UE, one or more sidelink messages using one or more sidelink resources of the second set of sidelink resources, the one or more sidelink resources based on the preference of the first UE for the sidelink resources indicated by the bitmap.

A method for wireless communication at a first UE is described. The method may include receiving, from a second UE, a coordination message including a bitmap associated with a set of sidelink resources, where the bitmap indicates a preference of the second UE for a sidelink resource of the set of sidelink resources and transmitting, to the second UE, one or more sidelink messages using one or more sidelink resources of the set of sidelink resources, where the one or more sidelink resources are based on the preference of the second UE for the sidelink resource indicated by the bitmap.

An apparatus for wireless communication at a first UE is described. The apparatus may include a processor, memory coupled with the processor, and instructions stored in the memory. The instructions may be executable by the processor to cause the apparatus to receive, from a second UE, a coordination message including a bitmap associated with a set of sidelink resources, where the bitmap indicates a preference of the second UE for a sidelink resource of the set of sidelink resources and transmit, to the second UE, one or more sidelink messages using one or more sidelink resources of the set of sidelink resources, where the one or more sidelink resources are based on the preference of the second UE for the sidelink resource indicated by the bitmap.

Another apparatus for wireless communication at a first UE is described. The apparatus may include means for receiving, from a second UE, a coordination message including a bitmap associated with a set of sidelink resources, where the bitmap indicates a preference of the second UE for a sidelink resource of the set of sidelink resources and means for transmitting, to the second UE, one or more sidelink messages using one or more sidelink resources of the set of sidelink resources, where the one or more sidelink resources are based on the preference of the second UE for the sidelink resource indicated by the bitmap.

A non-transitory computer-readable medium storing code for wireless communication at a first UE is described. The code may include instructions executable by a processor to receive, from a second UE, a coordination message including a bitmap associated with a set of sidelink resources, where the bitmap indicates a preference of the second UE for a sidelink resource of the set of sidelink resources and transmit, to the second UE, one or more sidelink messages using one or more sidelink resources of the set of sidelink resources, where the one or more sidelink resources are based on the preference of the second UE for the sidelink resource indicated by the bitmap.

In some examples of the method, apparatuses, and non-transitory computer-readable medium described herein, the preference of the second UE may be based on whether an RSRP associated with the sidelink resource satisfies a threshold RSRP.

Some examples of the method, apparatuses, and non-transitory computer-readable medium described herein may further include operations, features, means, or instructions for transmitting, to the second UE, an indication of the threshold RSRP for generating the bitmap.

Some examples of the method, apparatuses, and non-transitory computer-readable medium described herein may further include operations, features, means, or instructions for transmitting, to the second UE, a message indicating a priority level associated with the one or more sidelink messages, the priority level corresponding to the threshold RSRP.

In some examples of the method, apparatuses, and non-transitory computer-readable medium described herein, the threshold RSRP may be a pre-configured threshold at the first UE and the second UE, configured by a network, common to the first UE and the second UE, or a combination thereof.

In some examples of the method, apparatuses, and non-transitory computer-readable medium described herein, the preference of the second UE may be based on whether a priority level associated with the sidelink resource satisfies a priority threshold associated with the set of sidelink resources.

In some examples of the method, apparatuses, and non-transitory computer-readable medium described herein, the priority threshold may be a pre-configured priority threshold at the first UE and the second UE, configured by a network, common to the first UE and the second UE, or a combination thereof.

Some examples of the method, apparatuses, and non-transitory computer-readable medium described herein may further include operations, features, means, or instructions for transmitting, to the second UE, an indication of the priority threshold for generating the bitmap.

In some examples of the method, apparatuses, and non-transitory computer-readable medium described herein, the coordination message includes a set of bitmaps including the bitmap, each bitmap of the set of bitmaps corresponding to a respective priority threshold of a set of priority thresholds.

In some examples of the method, apparatuses, and non-transitory computer-readable medium described herein, the coordination message further includes a first indication of a priority threshold used to generate the bitmap, a second indication of a threshold RSRP used to generate the bitmap, a third indication of whether the preference of the second UE may be associated with a preferred sidelink resource or a non-preferred sidelink resource, or a combination thereof.

In some examples of the method, apparatuses, and non-transitory computer-readable medium described herein, each bit of the bitmap corresponds to a respective sidelink resource of the set of sidelink resources, each bit indicates a respective preference of the second UE for the respective sidelink resource, and the coordination message includes an SCI message, a MAC-CE message, an RRC message, or a combination thereof.

### BRIEF DESCRIPTION OF THE DRAWINGS

FIGS. 1 and 2 illustrate examples of wireless communications systems that support techniques for sidelink user equipment (UE) coordination in accordance with aspects of the present disclosure.

FIG. 3 illustrates an example of a resource diagram that supports techniques for sidelink UE coordination in accordance with aspects of the present disclosure.

FIG. 4 illustrates an example of a process flow that supports techniques for sidelink UE coordination in accordance with aspects of the present disclosure.

FIGS. 5 and 6 show block diagrams of devices that support techniques for sidelink UE coordination in accordance with aspects of the present disclosure.

FIG. 7 shows a block diagram of a communications manager that supports techniques for sidelink UE coordination in accordance with aspects of the present disclosure.

FIG. 8 shows a diagram of a system including a device that supports techniques for sidelink UE coordination in accordance with aspects of the present disclosure.

FIGS. 9 through 15 show flowcharts illustrating methods that support techniques for sidelink UE coordination in accordance with aspects of the present disclosure.

### DETAILED DESCRIPTION

Some wireless communications systems may support sidelinks for communications between communication devices. Sidelinks may refer to any communication link between similar communication devices such as user equipments (UEs). It is noted that while various examples provided herein are discussed for UE sidelink devices, such sidelink techniques may be used for any type of wireless devices that use sidelink communications. For example, a sidelink may support one or more of device-to-device (D2D) communications, vehicle-to-everything (V2X) or vehicle-to-vehicle (V2V) communications, message relaying, discovery signaling, beacon signaling, or other signals transmitted over-the-air from one UE to one or more other UEs.

In some examples, sidelink communications may be reservation based. For example, a UE may monitor for and decode one or more reservation messages (e.g., sidelink control signaling such as sidelink control information (SCI) messages) and may determine which sidelink resources are reserved for other sidelink communications and which sidelink resources are available for sidelink communications based on the reservation messages. Additionally, the UE may transmit reservation messages to reserve available sidelink resources for sidelink communications. In some cases, however, the UE may fail to receive (e.g., decode) one or more reservation messages, which may result in the UE erroneously determining that one or more reserved sidelink resources are available. Consequently, the UE may transmit a sidelink message over the one or more reserved sidelink resources. As a result, collisions between sidelink messages may occur, thereby increasing interference and reducing reliability and, in some cases, degrading latency, data rates, and resource utilization, for example, due to retransmitting failed sidelink messages.

Techniques, systems, and devices are described herein for improving sidelink resource reservation and selection schemes by indicating UE preferences for sidelink resources. For example, a first UE may monitor a first set of sidelink resources for reservation messages (e.g., SCI) to determine which sidelink resources of a second set of sidelink resources are available and which sidelink resources are reserved (e.g., unavailable). Based on the monitoring, the first UE may generate a bitmap associated with the second set of sidelink resources that indicates preferences of the first UE for the sidelink resources of the second set of sidelink resources. For example, each bit of the bitmap may correspond to a respective sidelink resource of the second set of sidelink resources and may indicate a respective preference (e.g., preferred or non-preferred) for the respective sidelink resource. In some examples, a preferred sidelink resource may be a sidelink resource that is determined to be available by the first UE and is, thus, preferred for receiving a sidelink message at the first UE compared to a non-preferred sidelink resource, which may be a sidelink resource that is determined to be reserved by the first UE. In some cases, the first UE may determine that a sidelink resource is non-preferred if a reference signal received power (RSRP) of an associated SCI message satisfies (e.g., is greater than, greater than or equal to) a threshold RSRP, a priority level associated with the sidelink resource fails to satisfy (e.g., is less than, less than or equal to) a threshold priority, or a combination thereof. Additionally, or alternatively, the first UE may determine that a sidelink is preferred if the RSRP fails to satisfy (e.g., is less than, less than or equal to) the threshold RSRP, the priority level satisfies (e.g., is greater than, greater than or equal to) the threshold priority, or a combination thereof.

The first UE may transmit a coordination message to a second UE that includes the bitmap. Based on the preferences indicated by the bitmap, the second UE may select one or more sidelink resources of the second set of sidelink resources (e.g., one or more preferred sidelink resources) and may transmit one or more sidelink messages (e.g., to the first UE) using the selected one or more sidelink resources. In this way, the second UE may select sidelink resources based on preferences indicated by the first UE in addition to sidelink resource reservations detected by the second UE. The preferences may indicate information different from the detected sidelink resource reservations (e.g., indicate undetected sidelink resource reservations), which may improve sidelink resource selection at the second UE and sidelink communication reliability.

Aspects of the subject matter described in this disclosure may be implemented to realize one or more of the following potential improvements, among others. The techniques employed by the UEs may provide benefits and enhancements to the operation of the UEs. For example, operations performed by the UEs may provide improvements to sidelink communications. In some examples, indicating UE preferences for sidelink resources may UE sidelink resource selection procedures, thereby improving sidelink reliability, resource usage, and data rates of sidelink communications. In some other examples, indicating UE preferences for sidelink resources may provide improvements to latency, power consumption, coordination between devices, battery life, spectral efficiency, and processing capability among other benefits.

Aspects of the disclosure are initially described in the context of wireless communications systems. Aspects of the disclosure are additionally described in the context of a resource diagram and a process flow. Aspects of the disclosure are further illustrated by and described with reference to apparatus diagrams, system diagrams, and flowcharts that relate to techniques for sidelink UE coordination.

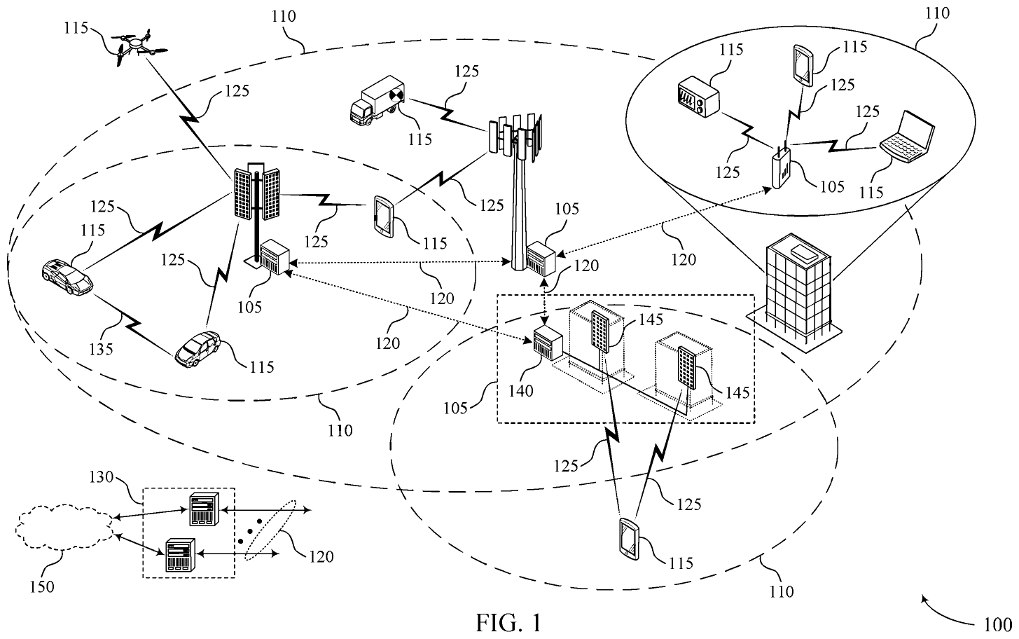

FIG. 1 illustrates an example of a wireless communications system 100 that supports techniques for sidelink UE coordination in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or differ radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a D2D communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using V2X communications, V2V communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below: 300 MHZ.

The wireless communications system 100 may also operate in a super high frequency (SHF) region using frequency bands from 3 GHZ to 30 GHZ, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

In some examples, the wireless communications system 100 may be an example of a sidelink network. Here, the sidelink network may support one or more resource allocation modes to coordinate sidelink communications between UEs 115 (e.g., over D2D communication links 135, over PC5 links). For example, the sidelink network may be configurable to operate according a Mode 1 resource allocation mode and/or a Mode 2 resource allocation mode. While operating in Mode 1, the sidelink network (e.g., sidelink communications over the sidelink network) may be managed (e.g., coordinated) by a base station 105. For example, during Mode 1 operation, the base station 105 may manage sidelink resource allocation over the sidelink network.

While operating in Mode 2, the sidelink network may not be managed or coordinated by the base station 105. Without coordination or management of sidelink resources of the sidelink network during the Mode 2 operation, UEs 115 may follow contention-based access procedures in which the various UEs 115 may reserve sidelink resources of the sidelink network. For example, during Mode 2 operation, a UE 115 may monitor the sidelink network to determine if other UEs 115 are attempting to transmit over the sidelink network. For instance, the UE 115 may decode one or more reservation messages (e.g., sidelink control channel transmissions such as SCI messages, SCI-1 messages, SCI-2 messages, request-to-send-messages, or some other sidelink control channel transmissions) and may determine which sidelink resources are reserved for other sidelink communications and which sidelink resources are available for sidelink communications based on the reservation messages. In some examples, the UE 115 may determine whether a sidelink resource is reserved based on measuring an RSRP of an associated reservation message. In some other examples, the UE 115 may determine whether a sidelink resource is reserved based on a priority level of an associated reservation message. In some cases, the UE 115 may determine which sidelink resources are available for sidelink communications based on reservation messages decoded during a sensing window, where the sensing window corresponds to some duration of time prior to the arrival of a packet of information. In some examples, the packet arrival may trigger the UE 115 to determine which sidelink resources are available and to reserve sidelink resources (e.g., via random selection of the available sidelink resources).

In some examples, UEs 115 may be configured with one or more sidelink resource pools from which to select and reserve sidelink resources (e.g., during Mode 2 operation). In some cases, sidelink resource pools may include transmit sidelink resource pools (e.g., sets of sidelink resources over which the UE 115 may transmit sidelink messages) and receive sidelink resource pools (e.g., sets of sidelink resources over which the UE 115 may receive sidelink messages). The sidelink resource pools may be configured for Mode 1 communications or for Mode 2 communications. In some examples, a sidelink resource pool configuration for a sidelink resource pool may include a physical sidelink shared channel (PSSCH) configuration, a physical sidelink control channel (PSCCH) configuration, physical sidelink feedback channel (PSFCH) configuration, a quantity of subchannels in the sidelink resource pool, a subchannel size, a starting resource block of the sidelink resource pool, a modulation and coding scheme (MCS) associated with the sidelink resource pool, a sensing configuration, a power control configuration, a constant bit rate (CBR), or a combination thereof.

Various aspects of the described techniques support indicating UE preferences for sidelink resources to improve sidelink resource reservation and selections schemes (e.g., during Mode 2 operation), increase reliability, and reduce sidelink collisions, among other benefits. For example, a first UE 115 may monitor a sidelink channel for SCI during a sensing window to determine which sidelink resources of a sidelink resource pool are available and which sidelink resources are reserved (e.g., unavailable). Based on the monitoring, the first UE 115 may determine whether a given sidelink resource of the sidelink resource pool is preferred or non-preferred. For example, the first UE 115 may determine that a sidelink resource is a preferred sidelink resource for receiving a sidelink message at the first UE 115 sidelink resource is available (e.g., based on an RSRP of an associated SCI message, based on a priority level associated with the sidelink resource, or both). Alternatively, the first UE 115 may determine that the sidelink resource is a non-preferred sidelink resource for receiving the sidelink message at the first UE 115 if the sidelink resource is reserved (e.g., based on the RSRP, based on the priority level, or both).

The first UE 115 may generate a bitmap associated with the sidelink resource pool that indicates preferences of the first UE 115 for the sidelink resources of the sidelink resource pool. For example, each bit of the bitmap may correspond to a respective sidelink resource of the sidelink resource pool and may indicate a respective preference (e.g., preferred or non-preferred) for the respective sidelink resource. The first UE 115 may transmit a coordination message to a second UE 115 that includes the bitmap. Based on the preferences indicated by the bitmap, the second UE 115 may select one or more sidelink resources of the sidelink resource pool (e.g., one or more preferred sidelink resources) and may transmit one or more sidelink messages (e.g., to the first UE 115) using the selected one or more sidelink resources.

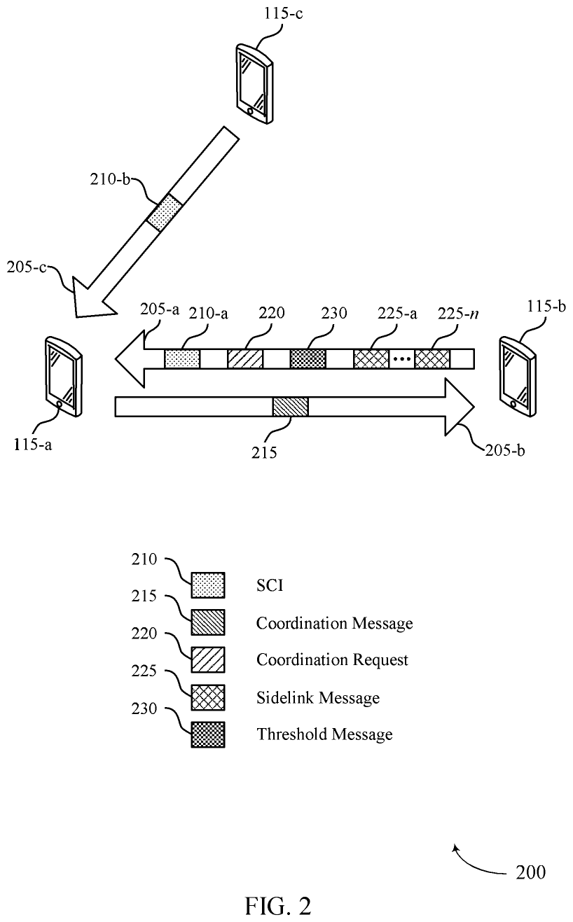

FIG. 2 illustrates an example of a wireless communications system 200 that supports techniques for sidelink UE coordination in accordance with aspects of the present disclosure. The wireless communications system 200 may implement aspects of the wireless communications system 100 or may be implemented by aspects of the wireless communications system 100. For example, the wireless communications system 200 may include a UE 115-a, a UE 115-b, and a UE 115-c which may be examples of a UE 115 described with reference to FIG. 1. In some examples, the wireless communications system 200 may support multiple radio access technologies including 4G systems such as LTE systems, LTE-A systems, or LTE-A Pro systems, and 5G systems which may be referred to as NR systems. The wireless communications system 200 may support sidelink resource preference indications to support improvements to reliability, sidelink resource selection and reservation, resource usage, data rates, spectral efficiency, latency, coordination between devices, power consumption, battery life, and processing capability among other benefits.

The wireless communications system 200 may support sidelink communications between the UE 115-a and the UE 115-b and between the UE 115-a and the UE 115-c. For example, the UE 115-b may transmit and the UE 115-a may receive sidelink communications over a sidelink 205-a, and the UE 115-a may transmit and the UE 115-b may receive sidelink communications over a sidelink 205-b. Additionally, the UE 115-c may transmit and the UE 115-c may receive sidelink communications over a sidelink 20-5c. In some cases, the sidelinks 205 may be respective examples of D2D communication links 135 as described with reference to FIG. 1.

The wireless communications system 200 may be configured to operate according to a Mode 2 resource allocation mode. For example, the UEs 115 may monitor respective sidelinks 205 for SCI 210 (e.g., during a sensing window) in order to determine which sidelink resources are available and which sidelink resources are reserved (e.g., unavailable). For instance, a UE 115 may transmit SCI 210 to one or more UEs 115 to reserve one or more available sidelink resources. Accordingly, other UEs 115 may receive and decode the SCI 210 to determine which sidelink resources are reserved by the SCI 210 (e.g., and by the UE 115). In some cases, the sidelink resources reserved by SCI 210 may be randomly selected from a set of available sidelink resources by the UE 115 that transmits the SCI 210. For example, a UE 115 may determine which sidelink resources are available based on SCI 210 decoded by the UE 115 during a sensing window and may randomly select one or more of the available sidelink resources to reserve, via SCI 210, for transmission of one or more sidelink messages 225.

In some cases, however, the UE 115 may fail to decode one or more SCIs 210 and may subsequently transmit SCI 210 that reserves sidelink resources that are reserved by another UE 115 (e.g., by the one or more SCIs 210). For example, the UE 115-b may fail to decode SCI 210-b transmitted by the UE 115-c (e.g., due to being outside of a sidelink communication range of the UE 115-c, due to poor signal quality of the SCI 210-b at the UE 115-b, etc.), which may result in the UE 115-b failing to determine that the sidelink resources reserved by SCI 210-b are reserved. In some cases, the UE 115-b may select one or more of the reserved sidelink resources and may transmit SCI 210-a to reserve the selected sidelink resources, thus resulting in conflicting reservations. Consequently, collisions and interference between sidelink messages 225 transmitted over the conflicting sidelink resources (e.g., by the UE 115-b and the UE 115-c) may suffer reduced reliability, and in some cases, may fail to be properly decoded.

In order to increase sidelink communication reliability and sidelink resource selection robustness, the UE 115-a may be configured to indicate its preferences for sidelink resources, which may be used by another UE 115 (e.g., UE 115-b) in selecting sidelink resources. For example, the UE 115-a may monitor a first set of sidelink resources (e.g., corresponding to a sensing window) for SCI 210 from one or more UEs 115 (e.g., UE 115-b, UE 115-c, one or more other UEs 115 (not shown), or a combination thereof). In some examples, the UE 115-a may receive and decode the SCI 210 from the one or more UEs 115 (e.g., SCI 210-a, SCI 210-b, other SCI 210, or a combination thereof) and may determine corresponding sidelink resource reservations of a second set of sidelink resources. Based on the SCI 210, the UE 115-a may determine which sidelink resources of the second set of sidelink resources are available and which sidelink resources of the second set of sidelink resources are reserved. In some cases, the UE 115-a may not receive or decode SCI 210 from any UE 115, in which case the UE 115-a may determine that each of the sidelink resources of the second set of sidelink resources are available.

Based on the availability determination, the UE 115-a may determine a preference of the UE 115-a for one or more of the sidelink resources of the second set of sidelink resources. The preference of the UE 115-a for a sidelink resource may indicate whether the sidelink resource is a preferred or a non-preferred sidelink resource for receiving sidelink messages from the one or more UEs 115 (e.g., sidelink messages 225 from the UE 115-b). In some examples, the UE 115-a may determine that a sidelink resource is preferred if the sidelink resource is available and may determine that a sidelink resource is non-preferred if the sidelink resource is reserved. In some cases, if the preference of the UE 115-a is associated with receiving a sidelink message 225 from the UE 115-b and the UE 115-b determine that a sidelink resource is reserved by the UE 115-b (e.g., via SCI 210-a), the UE 115-a may determine that the sidelink resource is preferred.

Additionally, or alternatively, the UE 115-a may determine its preference for a sidelink resource based on an RSRP of the SCI 210 that reserves the sidelink resource. For example, the UE 115-a may measure the RSRP of SCI 210 that reserves one or more sidelink resources of the second set of sidelink resources (e.g., SCI 210-a, SCI 210-b, other SCI 210) and may compare the measured RSRP to a threshold RSRP. Based on the comparison, the UE 115-a may determine whether the measured RSRP satisfies the threshold RSRP and may determine the preference for the one or more sidelink resources accordingly. For example, if the measured RSRP satisfies (e.g., is greater than, is greater than or equal to) the threshold RSRP, the UE 115-a may determine that the one or more sidelink resources reserved by the SCI 210 are non-preferred. Alternatively, if the measured RSRP fails to satisfy (e.g., is less than, is less than or equal to) the threshold RSRP, the UE 115-a may determine that the one or more sidelink resources reserved by the SCI 210 are preferred. That is, in some cases, the UE 115-a may determine that a sidelink resource is preferred (e.g., available), even if the sidelink resource is reserved by SCI 210, if an RSRP of the SCI 210 fails to satisfy a threshold RSRP.

The UE 115-a may determine the threshold RSRP according to various techniques. In some examples, the threshold RSRP may be a pre-configured threshold RSRP that is common to the UEs 115 of the wireless communications system 200 (e.g., common to the UE 115-a, the UE 115-b, and the UE 115-c). In some cases, the threshold RSRP may be configured by a network (e.g., a core network 130 via a base station 105 described with reference to FIG. 1) and may be common to the UEs 115 of the wireless communications system 200.

In some examples, the threshold RSRP may be explicitly indicated to the UE 115-a. For example, the UE 115-b may transmit a coordination request 220 (e.g., before, after, or during the sensing window) that requests the UE 115-a to indicate preference information for the second set of sidelink resources to the UE 115-b. The coordination request 220 may additionally, or alternatively, indicate the threshold RSRP for the UE 115-ato use in its sidelink resource preference determination. In some examples, the coordination request 220 may indicate a value of threshold RSRP. In some other examples, the coordination request 220 may indicate an index of a set of indexes, the index corresponding to the value of the threshold RSRP of a set of values of the threshold RSRP. In some cases, the value of the threshold RSRP may have units of decibel milliwatts (dBm). In some examples, the threshold RSRP may be a power spectral density (PSD) RSRP threshold associated with the second set of sidelink resources. For example, a PSD RSRP threshold may indicate the received power within a channel bandwidth of a subchannel of the second set of sidelink resources that may satisfy the threshold RSRP. In some examples, the UE 115-b may transmit the coordination request 220 via an SCI-2 message, MAC-control element (MAC-CE) signaling, RRC signaling, or a combination thereof.

In some examples, the threshold RSRP may be implicitly indicated to the UE 115-a. For example, the UE 115-a may determine the threshold RSRP based on mapping a priority level associated with a transmission of the UE 115-b to the threshold RSRP. For instance, the SCI 210-a may indicate a priority level associated with the sidelink resources reserved by the SCI 210-a. Additionally, or alternatively, the coordination request 220 may indicate a priority level associated with sidelink messages 225 transmitted by the UE 115-b, the sidelink resources reserved by the SCI 210-a, or a combination thereof. Here, the coordination request 220) may not include the indication of the threshold RSRP. The priority level may correspond to a particular threshold RSRP of a set of threshold RSRPs. Accordingly, the UE 115-a may map the priority level (e.g., indicated by the SCI 210-a or the coordination request 220) to the corresponding threshold RSRP to determine the threshold RSRP. In some examples, a mapping between a set of priority levels that includes the priority level and the set of threshold RSRPs may be a preconfigured mapping (e.g., common to the UEs 115 of the wireless communications system 200). In some other examples, the mapping may be configured by a network (e.g., and may be common to the UEs 115 of the wireless communications system). In some cases, as priority level increases, the corresponding threshold RSRP may also increase, and vice versa.

In some examples, the UE 115-a may select the threshold RSRP such that a threshold percentage of the second set of sidelink resources are determined to be preferred or non-preferred. For example, the UE 115-a may select the threshold RSRP such that at least x percent of the second set of sidelink resources are determined to be preferred, where x is some value from 0 to 100. That is, the UE 115-a may select the threshold RSRP such that at least x percent of the second set of sidelink resources are either unreserved (e.g., available) or are reserved but by an SCI 210 with an RSRP that fails to satisfy the threshold RSRP. Alternatively, the UE 115-a may select the threshold RSRP such that at least y percent of the second set of sidelink resources are determined to be non-preferred (e.g., satisfy the threshold RSRP), where y is some value from 0 to 100. That is, the UE 115-a may select the threshold RSRP such that at least y percent of the second set of sidelink resources are reserved by an SCI 210 with an RSRP that satisfies the threshold RSRP. In some examples, the value of x, the value of y, or both, may be pre-configured values or configured by a network. In some examples, the UE 115-a may adjust a value of the threshold RSRP until the threshold percentage of the second set of sidelink resources are preferred or non-preferred. For example, if a quantity of preferred or non-preferred sidelink resources fails to satisfy the threshold percentage for a selected threshold RSRP, the UE 115-a may progressively increase or decrease (e.g., according to a preconfigured step size), respectively, the threshold RSRP until the threshold percentage is satisfied.

Additionally, or alternatively, the UE 115-a may determine its preference for a sidelink resource based on a priority level associated with the sidelink resource. For example, the UE 115-a may determine the priority level associated with the sidelink resource (e.g., based on SCI 210 that reserves the sidelink resource, based on a coordination request 220) and may compare the priority level to a priority threshold. Based on the comparison, the UE 115-a may determine whether the priority level satisfies the priority threshold and may determine the preference for the sidelink resource accordingly. For example, if the priority level satisfies (e.g., is greater than, is greater than or equal to) the priority threshold, the UE 115-a may determine that the sidelink resource is preferred. Alternatively, if the priority level fails to satisfy (e.g., is less than, is less than or equal to) the priority threshold, the UE 115-amay determine that the sidelink resource is non-preferred. In some examples, the UE 115-a may determine that the sidelink resource is preferred (e.g., available) irrespective of an RSRP associated with the sidelink resource. That is, in some examples, the UE 115-a may determine that a sidelink resource is preferred if the priority level satisfies the priority threshold even if the associated RSRP is relatively high (e.g., satisfies a threshold RSRP). In some other examples, if the priority level fails to satisfy the priority threshold, the UE 115-amay determine its preference for the sidelink resource based on the RSRP of the SCI 210 that reserves the sidelink resource (e.g., comparing the RSRP to a threshold RSRP). In some examples, unreserved sidelink resources may not be associated with a priority level and may be determined to be preferred by the UE 115-a.

The UE 115-a may determine the priority threshold according to various techniques. In some examples, the priority threshold may be a pre-configured priority threshold that is common to the UEs 115 of the wireless communications system 200. In some cases, the priority threshold may be configured by a network (e.g., a core network 130 via a base station 105 described with reference to FIG. 1) and may be common to the UEs 115 of the wireless communications system 200.

In some examples, the priority threshold may be explicitly indicated to the UE 115-a. For example, the UE 115-b may transmit a threshold message 230 to the UE 115-a that indicates the threshold priority to be used by the UE 115-a. In some examples, the threshold message 230 may be an example of a coordination request 220. In some cases, the UE 115-b may transmit the threshold message 230 via sidelink control signaling (e.g., an SCI-2 message), MAC-CE signaling, RRC signaling, or a combination thereof.

In some examples, the UE 115-a may select the priority threshold such that a threshold percentage of the second set of sidelink resources are determined to be preferred or non-preferred. For example, the UE 115-a may select the priority threshold such that at least w percent of the second set of sidelink resources are determined to be preferred (e.g., satisfy the priority threshold), where w is some value from 0 to 100. That is, the UE 115-a may select the priority threshold such that at least w percent of the second set of sidelink resources are either unreserved (e.g., available) or are reserved but are associated with a priority level that satisfies the priority threshold. Alternatively, the UE 115-a may select the priority threshold such that at least z percent of the second set of sidelink resources are determined to be non-preferred (e.g., fail to satisfy the priority threshold), where z is some value from 0 to 100. That is, the UE 115-a may select the priority threshold such that at least z percent of the second set of sidelink resources are reserved and associated with a priority level that fails to satisfy the threshold RSRP. In some examples, the value of w, the value of z or both, may be pre-configured values or configured by a network. In some examples, the UE 115-a may adjust the priority threshold until the threshold percentage of the second set of sidelink resources are preferred or non-preferred. For example, if a quantity of preferred or non-preferred sidelink resources fails to satisfy the threshold percentage for a selected priority threshold, the UE 115-a may progressively decrease or increase, respectively, the priority threshold until the threshold percentage is satisfied.

The UE 115-a may transmit a coordination message 215 to the UE 115-b that indicates its preferences for one or more sidelink resources of the second set of sidelink resources. For example, the UE 115-a may determine its preference for one or more of (e.g., each) sidelink resource of the second set of sidelink resource according to the techniques described herein and may generate a bitmap associated with the second set of sidelink resources that indicates a respective preference of the UE 115-a for the one or more sidelink resources of the second set of sidelink resources. The bitmap may include a bit for each of the one or more sidelink resources and each bit may indicate whether a corresponding sidelink resource is preferred or non-preferred. In some examples, the bitmap may be associated with preferred sidelink resources or non-preferred sidelink resources. For example, the bitmap may include a bit for each of the preferred sidelink resources. Alternatively, the bitmap may include a bit for each of the non-preferred sidelink resources. In some examples, the bitmap may include a bit for each sidelink resource of the set of sidelink resources and a value of the bit (e.g., a ‘0’ or a ‘1’) may indicate whether the sidelink resource is preferred or non-preferred.

The coordination message 215 may include the bitmap generated by the UE 115-a, which may indicate the preferences of the UE 115-a for the one or more sidelink resources of the second set of sidelink resources. The coordination message 215 may additionally include an indication of the priority threshold (e.g., the selected priority threshold) used to generate the bitmap (e.g., determine the preferences of the UE 115-a), an indication of the RSRP threshold used to generate the bitmap (e.g., the selected threshold RSRP), an indication that the bitmap (e.g., the preferences of the UE 115-a) indicates preferred sidelink resources, an indication that the bitmap (e.g., the preferences of the UE 115-a) indicates non-preferred sidelink resources, an indication of which bit value indicates a preferred sidelink resource and/or which bit value indicates a non-preferred sidelink resource, or a combination thereof. In some examples, the UE 115-a may transmit the coordination message 215 via physical layer signaling (e.g., sidelink control signaling), MAC signaling (e.g., a MAC-CE), RRC signaling, or a combination thereof.

In some examples, the UE 115-a may generate a set of bitmaps based on a set of priority thresholds. For example, the UE 115-a may determine a preference for one or more sidelink resources of the second set of sidelink resources based on a first priority threshold of a set of priority thresholds, the preference for the one or more sidelink resources based on a second priority threshold of the set of priority thresholds, and so on. For instance, NR V2X communications may be associated with priority levels 0 through 8. The UE 115-a may determine a preference for the one or more sidelink resources using one or more of priority levels 0 through 8 as the priority threshold. For each priority threshold used, the UE 115-a may generate a corresponding bitmap. Here, the UE 115-a may transmit the corresponding bitmaps to the UE 115-b in the coordination message 215.

The UE 115-b may receive the coordination message 215 and may transmit one or more sidelink messages 225 (e.g., a sidelink message 225-a through a sidelink message 225-n) to the UE 115-a based on the preference(s) indicated by the bitmap included in the coordination message 215. For example, the UE 115-b may select one or more sidelink resources of the second set of sidelink resources for transmitting the one or more sidelink messages 225 based on the indicated preferences. In some examples, the UE 115-b may down-select the one or more sidelink resources from sidelink resources reserved by the SCI 210-a. For example, if the UE 115-b transmitted the SCI 210-a to reserve one or more sidelink resources for the transmission of the one or more sidelink messages 225, the UE 115-b may determine whether any of the reserved sidelink resources are indicated to be non-preferred and may refrain from transmitting the one or more sidelink messages 225 using non-preferred sidelink resources. Instead, the UE 115-b may transmit the one or more sidelink messages 225 on remaining sidelink resources reserved by the SCI 210-a that are preferred. Additionally, or alternatively, the UE 115-b may transmit new SCI 210 that reserves one or more preferred sidelink resources and may transmit the one or more sidelink messages 225 using the preferred sidelink resources. In some other examples, the UE 115-bmay not have previously transmitted the SCI 210-a. Here, the UE 115-b may select one or more preferred sidelink resources of the second set of sidelink resources (e.g., that are not reserved by SCI 210 decoded at the UE 115-b) and may transmit SCI 210 (e.g., SCI 210-a) to reserve the one or more preferred sidelink resources. The UE 115-b may then transmit the one or more sidelink messages 225 using the one or more preferred sidelink resources.

In some examples, the UE 115-b may receive multiple coordination messages 215 from multiple UEs 115. For example, the UE 115-b may receive one or more coordination messages 215 in from one or more UEs 115 (e.g., different from the UE 115-a) in addition to the coordination message 215 received from the UE 115-a. Each coordination message 215 may indicate respective preferences of respective UEs 115 (e.g., via one or more bitmaps) for sidelink resources of the second set of sidelink resources. Here the UE 115-b may select one or more sidelink resources of second set of sidelink resources for transmitting sidelink messages 225 based on the multiple coordination messages 215 (e.g., the respective preferences indicated by the respective bitmaps).

Accordingly, the UE 115-b may select sidelink resources based on sidelink resource preferences indicated by the UE 115-a in addition to sidelink resource reservations detected by the UE 115-b, which may increase the reliability of the sidelink messages 225 transmitted by the UE 115-b.

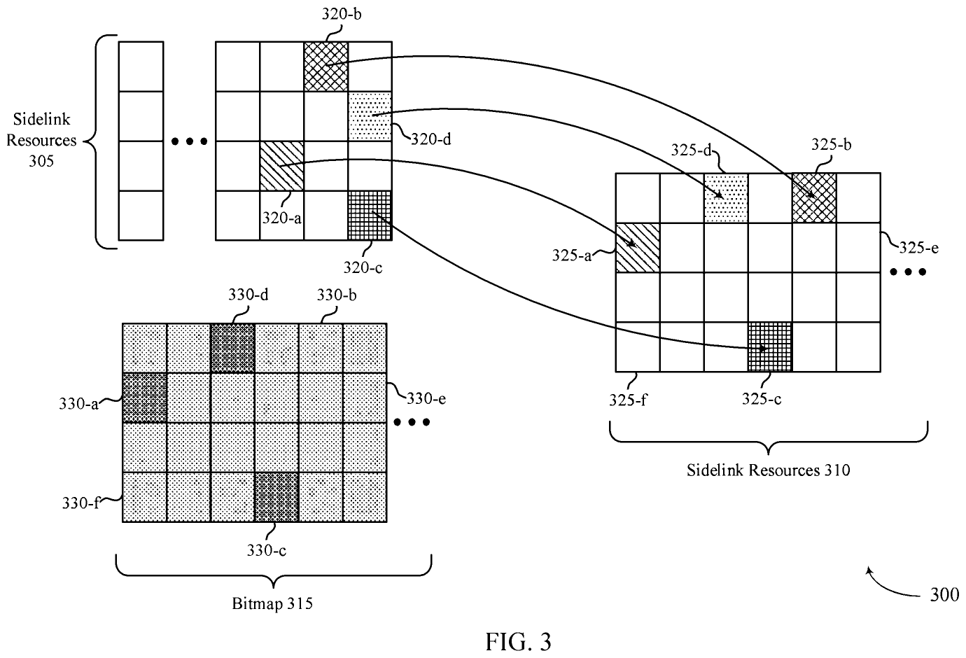

FIG. 3 illustrates an example of a resource diagram 300 that supports techniques for sidelink UE coordination in accordance with aspects of the present disclosure. The resource diagram 300 may be implemented by aspects of the wireless communications system 100 and 200 as described with reference to FIGS. 1 and 2, respectively. For example, the resource diagram 300 may be implemented by one or more UEs 115 to support sidelink resource preference indications which may provide improvements to reliability, sidelink resource selection and reservation, resource usage, data rates, spectral efficiency, latency, coordination between devices, power consumption, battery life, and processing capability among other benefits.

The resource diagram 300 depicts a set of sidelink resources 305 and a set of sidelink resource 310. The set of sidelink resources 305 may span a first quantity of slots in a time domain and a first quantity of subchannels in a frequency domain, and the set of sidelink resources 310 may span a second quantity of slots in the time domain and a second quantity of subchannels in the frequency domain. In some examples, the set of sidelink resources 305 may correspond to a sensing window during which a UE 115 may decode SCI to determine which sidelink resources 325 of the set of sidelink resources 310 are available for reservation. For example, the set of sidelink resources 305 may include SCI 320-a, SCI 320-b, SCI 320-c, and SCI 320-d, which may each reserve one or more sidelink resources 325 of the set of sidelink resource 310. In the example of FIG. 3, the SCI 320-a may reserve the sidelink resource 325-a of the set of sidelink resources 310, the SCI 320-b may reserve the sidelink resource 325-b of the set of sidelink resources 310, the SCI 320-c may reserve the sidelink resource 325-c of the set of sidelink resources 310, and the SCI 320-d may reserve the sidelink resource 325-d of the set of sidelink resources 310.

A UE 115 may monitor the set of sidelink resources 305 for the SCI 320 and may decode one or more of the SCI 320-a, the SCI 320-b, the SCI 320-c, and the SCI 320-d. The UE 115 may generate a bitmap 315 associated with the set of sidelink resources 310 based on the decoded SCI 320. For example, the UE 115 may determine a preference for one or more of the sidelink resources 325 based on the decoded SCI 320 (e.g., based on whether an RSRP of the SCI 320 satisfies a threshold, based on whether a priority level associated with the SCI 320 satisfies a priority threshold) and may generate the bitmap 315 based on the determined preferences. In the example of FIG. 3, the UE 115 may determine that the sidelink resources 325-a, 325-c, and 325-d are non-preferred resources and that the sidelink resource 325-b is a preferred sidelink resource. The UE 115 may also determine that remaining sidelink resources 325 of the set of sidelink resources 310 (e.g., sidelink resource 325-e, sidelink resource 325-f, etc.) are preferred sidelink resources, for example, based on the remaining sidelink resources 325 being unreserved.

The bitmap 315 may include bits 330 that correspond to the sidelink resources 325 and indicate the determined preferences for the sidelink resources 325. For example, each bit 330 may correspond (e.g., map) to a particular sidelink resource 325 and may indicate the determined preference for the particular sidelink resource 325. In an example, if the set of sidelink resources 310 corresponds to a thirty-two slot window with each slot spanning ten subchannel, the set of sidelink resources 310 may include three hundred and twenty sidelink resources 325 and the bitmap 315 may include three hundred and twenty bits 330, with each bit 330 corresponding to one of the sidelink resources 325. For instance, bit 330-a may correspond to sidelink resource 325-a, bit 330-b may correspond to sidelink resource 325-b, bit 330-c may correspond to sidelink resource 325-c, bit 330-d may correspond to sidelink resource 325-d, bit 330-e may correspond to sidelink resource 325-e, bit 330-f may correspond to sidelink resource 325-f, and so on. The UE 115 may generate the bitmap 315 such that bit 330-a, bit 330-c, and bit 330-d may indicate that the sidelink resource 325-a, the sidelink resource 325-c, and the sidelink resource 325-d are non-preferred sidelink resources, respectively, based on the preference determination. Additionally, the UE 115 may generate the bitmap 315 such that the remaining bits 330 (e.g., bit 330-b, bit 330-e, bit 330-f, etc.) may indicate that remaining sidelink resources 325 (e.g., the sidelink resource 325-b, the sidelink resource 325-e, the sidelink resource 325-f, etc.) are preferred sidelink resources based on the preference determination. In some examples, the UE 115 may generate the bitmap 315 to include the bits 330 corresponding to the non-preferred sidelink resources 325 and exclude the bits 330 corresponding to the preferred sidelink resource 325. In some other examples, the UE 115 may generate the bitmap 315 to include the bits 330 corresponding to the preferred sidelink resources 325 and exclude the bits 330 corresponding to the non-preferred sidelink resource 325

The UE 115 may transmit the bitmap 315 in a coordination message to a second UE 115. The second UE 115 may decode the bitmap 315 to determine the preferences of the UE 115 for the sidelink resources 325 and may transmit one or more sidelink messages to the UE 115 (e.g., or other UEs 115) based on the preferences. For example, the second UE 115 may exclude the sidelink resource 325-a, the sidelink resource 325-c, and the sidelink resource 325-d from a set of candidate sidelink resources 325 of the set of sidelink resource 310 that are available for selection based on the bitmap 315 indicating the sidelink resource 325-a, the sidelink resource 325-c, and the sidelink resource 325-d as non-preferred.

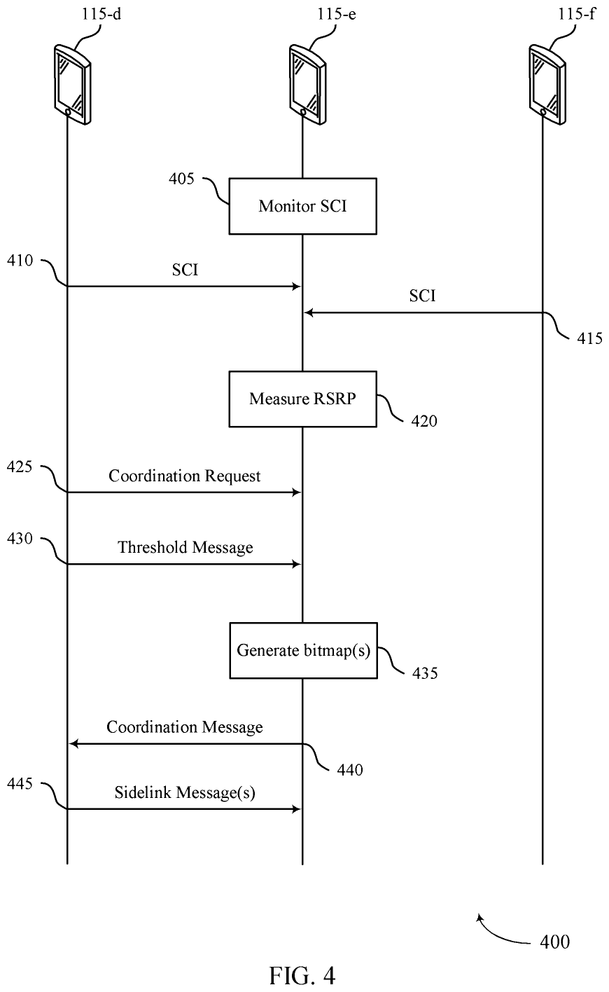

FIG. 4 illustrates an example of a process flow 400 that supports techniques for sidelink UE coordination in accordance with aspects of the present disclosure. The process flow 400 may implement aspects of the wireless communications systems 100 and 200 or may be implemented by aspects of the wireless communications system 100 and 200 as described with reference to FIGS. 1 and 2, respectively. For example, the process flow 400 may be implemented by a UE 115-d, a UE 115-e, and a UE 115-f to support indicating sidelink resource preferences to increase reliability of sidelink communications and improve sidelink resource selection and reservation schemes (e.g., during Mode 2 operation). The process flow 400 may further be implemented by the UE 115-d, the UE 115-e, and the UE 115-f to provide improvements to data rates, spectral efficiency, coordination between devices, power consumption, resource usage, battery life, and processing capability among other benefits.

The UE 115-d, the UE 115-e, and the UE 115-f may be examples of a UE 115, as described with reference to FIGS. 1 and 2. In the following description of the process flow 400, the operations may be performed in different orders or at different times. Some operations may also be omitted from the process flow 400, and other operations may be added to the process flow 400.

At 405, the UE 115-e may monitor a first set of sidelink resources for SCI. For example, the first set of sidelink resources may correspond to a sensing window during which other UEs 115 (e.g., the UE 115-d, the UE 115-f, or other UEs 115) may transmit SCI to reserve one or more sidelink resources of a second set of sidelink resources.

At 410, the UE 115-d may transmit first SCI to the UE 115-e, and the UE 115-emay decode the first SCI to determine one or more sidelink resources of the second set of sidelink resources reserved by the UE 115-d.

At 415, the UE 115-f may transmit second SCI to the UE 115-e, and the UE 115-emay decode the second SCI to determine one or more sidelink resources of the second set of sidelink resources reserved by the UE 115-f.

At 420, the UE 115-e may measure an RSRP of the first SCI, the second SCI, or a combination thereof.

At 425, the UE 115-d may transmit a coordination request to the UE 115-e. In some examples, the coordination request may indicate for the UE 115-e to determine a preference of the UE 115-e for one or more sidelink resources of the second set of sidelink resources. In some cases, the coordination request may indicate a threshold RSRP for the UE 115-e to use to determine the preference for the one or more sidelink resources. In some examples, the coordination request may indicate a priority level associated with sidelink resources reserved by the UE 115-d or associated with sidelink messages transmitted by the UE 115-d, where the priority level maps to a threshold RSRP of a set of threshold RSRPs. In some cases, the coordination request may indicate a priority threshold for the UE 115-e to use to determine the preference for the one or more sidelink resources. The UE 115-d may transmit the coordination request to the UE 115-e via sidelink control signaling (e.g., SCI), MAC signaling (e.g., a MAC-CE), RRC signaling, or a combination thereof.

At 430, the UE 115-d may transmit a threshold message that indicates the priority threshold for the UE 115-e to use to determine the preference for the one or more sidelink resources. The UE 115-d may transmit the threshold message to the UE 115-e via sidelink control signaling (e.g., SCI), MAC signaling (e.g., a MAC-CE), RRC signaling, or a combination thereof.

At 435, the UE 115-e may generate a bitmap that indicates the preferences of the UE 115-e for the one or more sidelink resources of the second set of sidelink resources. For example, the UE 115-e may determine the preferences for the one or more sidelink resources (e.g., whether each of the one or more sidelink resources are preferred or non-preferred) based on the first SCI, the second SCI, an RSRP of the first SCI, an RSRP of the second SCI, the threshold RSRP, the priority threshold, or a combination thereof. The UE 115-e may generate the bitmap including bits that correspond to the one or more sidelink resources and indicate a respective preference for the corresponding sidelink resource. In some examples, the UE 115-e may generate multiple bitmaps. For example, the UE 115-e may generate a respective bitmap for two or more priority thresholds of a set of priority thresholds.

At 440, the UE 115-e may transmit a coordination message to the UE 115-d that includes the bitmap. In some examples, the coordination message may further include an indication of the priority threshold used to generate the bitmap, an indication of the threshold RSRP used to generate the bitmap, an indication of whether the preferences for the one or more sidelink resources are associated with preferred sidelink resources or non-preferred sidelink resources, or a combination thereof. In some instances, the coordination message may include multiple bitmaps generated by the UE 115-e. In some cases, the UE 115-e may transmit the coordination message in SCI, a MAC-CE, an RRC message, or a combination thereof.

At 445, the UE 115-d may transmit one or more sidelink messages based on the coordination message. For example, the UE 115-d may receive the coordination message and may decode the bitmap(s) to determine the preferences of the UE 115-e for the one or more sidelink resources of the second set of sidelink resources. The UE 115-d may select one or more preferred sidelink resources of the second set of sidelink resources and may transmit the one or more sidelink messages using the one or more preferred sidelink resources.

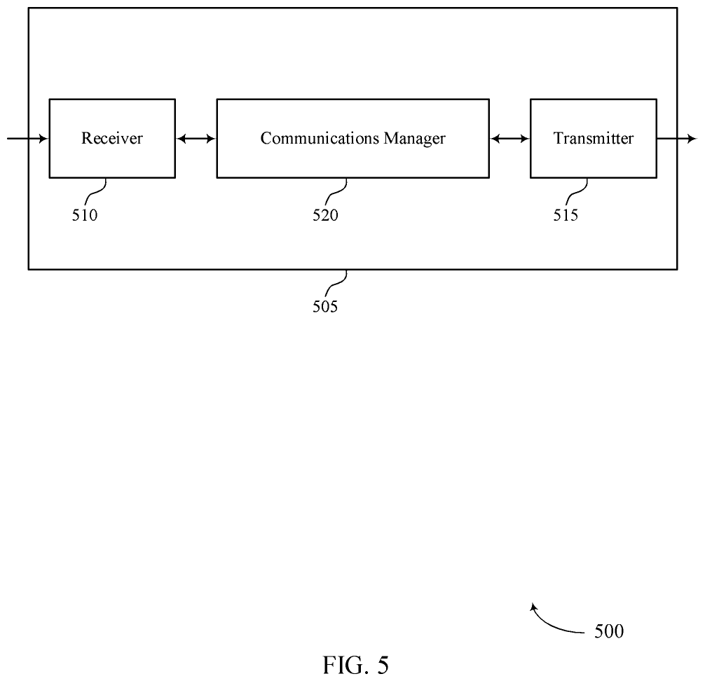

FIG. 5 shows a block diagram 500 of a device 505 that supports techniques for sidelink UE coordination in accordance with aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for sidelink UE coordination). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for sidelink UE coordination). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of techniques for sidelink UE coordination as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 520 may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communication at a first UE in accordance with examples as disclosed herein. For example, the communications manager 520 may be configured as or otherwise support a means for monitoring a first set of sidelink resources for SCI from one or more UEs. The communications manager 520 may be configured as or otherwise support a means for generating, based on the monitoring, a bitmap associated with a second set of sidelink resources, where the bitmap indicates a preference of the first UE for a sidelink resource of the second set of sidelink resources. The communications manager 520 may be configured as or otherwise support a means for transmitting, to a second UE, a coordination message including the bitmap.

Additionally, or alternatively, the communications manager 520 may support wireless communication at a first UE in accordance with examples as disclosed herein. For example, the communications manager 520 may be configured as or otherwise support a means for receiving, from a second UE, a coordination message including a bitmap associated with a set of sidelink resources, where the bitmap indicates a preference of the second UE for a sidelink resource of the set of sidelink resources. The communications manager 520 may be configured as or otherwise support a means for transmitting, to the second UE, one or more sidelink messages using one or more sidelink resources of the set of sidelink resources, where the one or more sidelink resources are based on the preference of the second UE for the sidelink resource indicated by the bitmap.

By including or configuring the communications manager 520 in accordance with examples as described herein, the device 505 (e.g., a processor controlling or otherwise coupled to the receiver 510, the transmitter 515, the communications manager 520, or a combination thereof) may support techniques reduced processing, reduced power consumption, and more efficient utilization of communication resources by indicating UE preferences for sidelink resources to increase sidelink reliability and reduce retransmissions of sidelink communications.

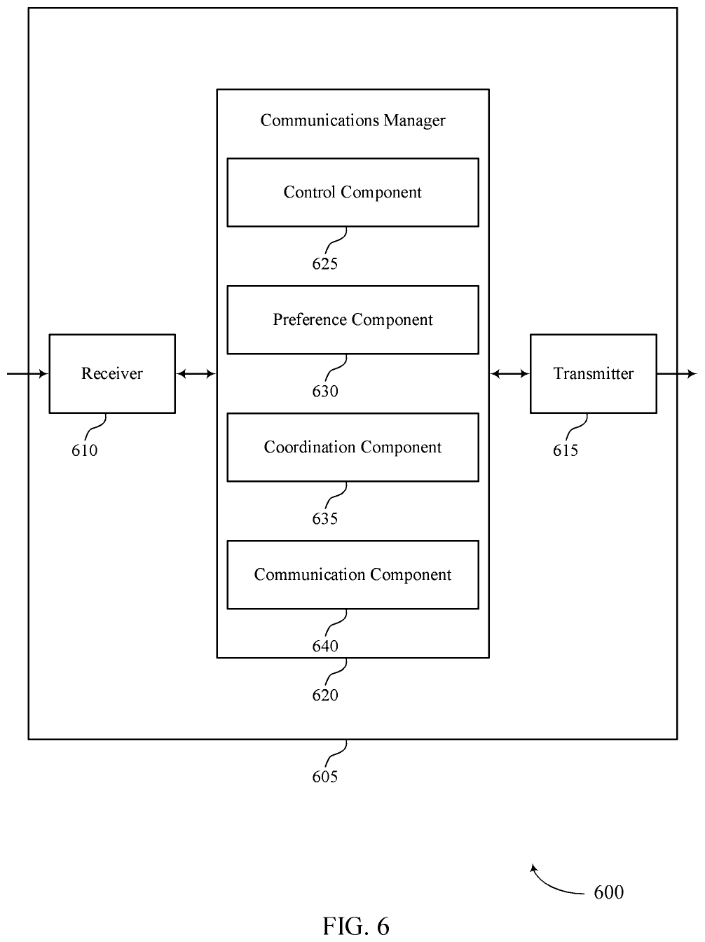

FIG. 6 shows a block diagram 600 of a device 605 that supports techniques for sidelink UE coordination in accordance with aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for sidelink UE coordination). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for sidelink UE coordination). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of techniques for sidelink UE coordination as described herein. For example, the communications manager 620 may include a control component 625, a preference component 630, a coordination component 635, a communication component 640, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a first UE in accordance with examples as disclosed herein. The control component 625 may be configured as or otherwise support a means for monitoring a first set of sidelink resources for SCI from one or more UEs. The preference component 630 may be configured as or otherwise support a means for generating, based on the monitoring, a bitmap associated with a second set of sidelink resources, where the bitmap indicates a preference of the first UE for a sidelink resource of the second set of sidelink resources. The coordination component 635 may be configured as or otherwise support a means for transmitting, to a second UE, a coordination message including the bitmap.

Additionally, or alternatively, the communications manager 620 may support wireless communication at a first UE in accordance with examples as disclosed herein. The coordination component 635 may be configured as or otherwise support a means for receiving, from a second UE, a coordination message including a bitmap associated with a set of sidelink resources, where the bitmap indicates a preference of the second UE for a sidelink resource of the set of sidelink resources. The communication component 640 may be configured as or otherwise support a means for transmitting, to the second UE, one or more sidelink messages using one or more sidelink resources of the set of sidelink resources, where the one or more sidelink resources are based on the preference of the second UE for the sidelink resource indicated by the bitmap.

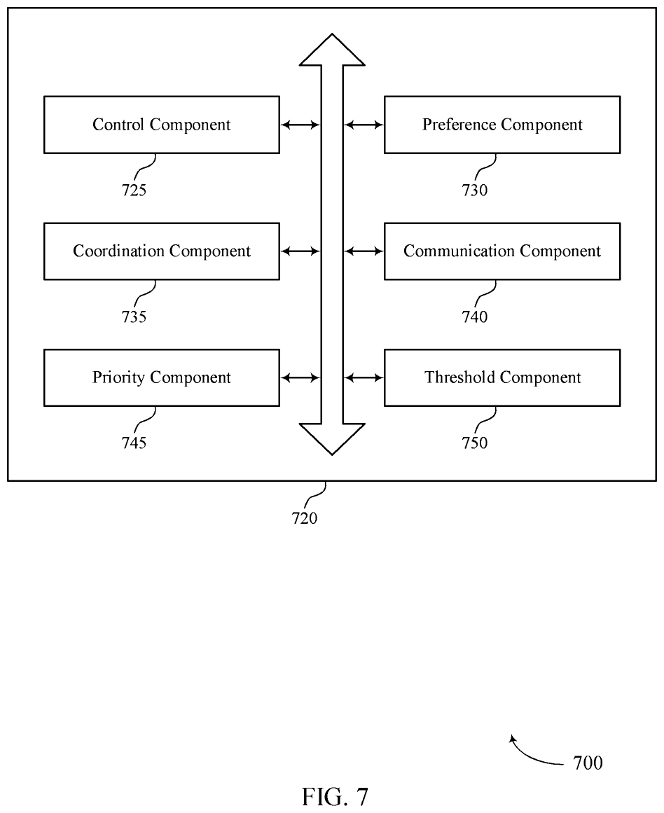

FIG. 7 shows a block diagram 700 of a communications manager 720 that supports techniques for sidelink UE coordination in accordance with aspects of the present disclosure. The communications manager 720 may be an example of aspects of a communications manager 520, a communications manager 620, or both, as described herein. The communications manager 720, or various components thereof, may be an example of means for performing various aspects of techniques for sidelink UE coordination as described herein. For example, the communications manager 720 may include a control component 725, a preference component 730, a coordination component 735, a communication component 740, a priority component 745, a threshold component 750, or any combination thereof. Each of these components may communicate, directly or indirectly, with one another (e.g., via one or more buses).

The communications manager 720 may support wireless communication at a first UE in accordance with examples as disclosed herein. The control component 725 may be configured as or otherwise support a means for monitoring a first set of sidelink resources for SCI from one or more UEs. The preference component 730 may be configured as or otherwise support a means for generating, based on the monitoring, a bitmap associated with a second set of sidelink resources, where the bitmap indicates a preference of the first UE for a sidelink resource of the second set of sidelink resources. The coordination component 735 may be configured as or otherwise support a means for transmitting, to a second UE, a coordination message including the bitmap.

In some examples, the control component 725 may be configured as or otherwise support a means for receiving the SCI from the one or more UEs based on the monitoring, where the SCI is associated with a subset of the second set of sidelink resources. In some examples, the control component 725 may be configured as or otherwise support a means for measuring an RSRP associated with the SCI, where generating the bitmap is based on the RSRP.

In some examples, the preference component 730 may be configured as or otherwise support a means for determining the preference of the first UE for the sidelink resource based on the RSRP and a threshold RSRP.

In some examples, the threshold RSRP is a pre-configured threshold at the first UE and the second UE, configured by a network, common to the first UE and the second UE, or a combination thereof.

In some examples, the threshold component 750 may be configured as or otherwise support a means for receiving, from the second UE, an indication of the threshold RSRP, where determining the preference of the first UE for the sidelink resource is based on the indication.

In some examples, the priority component 745 may be configured as or otherwise support a means for determining a priority level associated with a transmission of the second UE associated with the second set of sidelink resources. In some examples, the threshold component 750 may be configured as or otherwise support a means for determining the threshold RSRP from a set of threshold RSRPs corresponding to a set of priority levels including the priority level, the threshold RSRP corresponding to the priority level.

In some examples, the threshold component 750 may be configured as or otherwise support a means for determining the threshold RSRP such that an RSRP associated with at least a threshold percentage of the second set of sidelink resources satisfy the threshold RSRP.

In some examples, the priority component 745 may be configured as or otherwise support a means for determining a priority level associated with the sidelink resource of the second set of sidelink resources, where the preference of the first UE for the sidelink resource is based on whether the priority level satisfies a priority threshold associated with the second set of sidelink resources.

In some examples, the priority threshold is a pre-configured priority threshold at the first UE and the second UE, configured by a network, common to the first UE and the second UE, or a combination thereof.

In some examples, the threshold component 750 may be configured as or otherwise support a means for receiving, from the second UE, an indication of the priority threshold associated with the second set of sidelink resources, where determining the priority level is based on the indication of the priority threshold.

In some examples, the threshold component 750 may be configured as or otherwise support a means for determining the priority threshold such that a priority level corresponding to a threshold percentage of the second set of sidelink resources satisfy the priority threshold.

In some examples, the preference component 730 may be configured as or otherwise support a means for generating a set of bitmaps associated with the second set of sidelink resources, each bitmap of the set of bitmaps corresponding to a respective priority threshold of a set of priority thresholds, where the coordination message includes the set of bitmaps.

In some examples, the coordination message further includes a first indication of a priority threshold used to generate the bitmap, a second indication of a threshold RSRP used to generate the bitmap, a third indication of whether the preference of the first UE is associated with a preferred sidelink resource or a non-preferred sidelink resource, or a combination thereof.

In some examples, each bit of the bitmap corresponds to a respective sidelink resource of the second set of sidelink resources. In some examples, each bit indicates a respective preference of the first UE for the respective sidelink resource. In some examples, the coordination message includes an SCI message, a MAC-CE message, an RRC message, or a combination thereof.

In some examples, the communication component 740 may be configured as or otherwise support a means for receiving, from the second UE, one or more sidelink messages using one or more sidelink resources of the second set of sidelink resources, the one or more sidelink resources based on the preference of the first UE for the sidelink resource indicated by the bitmap.

Additionally, or alternatively, the communications manager 720 may support wireless communication at a first UE in accordance with examples as disclosed herein. In some examples, the coordination component 735 may be configured as or otherwise support a means for receiving, from a second UE, a coordination message including a bitmap associated with a set of sidelink resources, where the bitmap indicates a preference of the second UE for a sidelink resource of the set of sidelink resources. The communication component 740 may be configured as or otherwise support a means for transmitting, to the second UE, one or more sidelink messages using one or more sidelink resources of the set of sidelink resources, where the one or more sidelink resources are based on the preference of the second UE for the sidelink resource indicated by the bitmap.

In some examples, the preference of the second UE is based on whether an RSRP associated with the sidelink resource satisfies a threshold RSRP.

In some examples, the threshold component 750 may be configured as or otherwise support a means for transmitting, to the second UE, an indication of the threshold RSRP for generating the bitmap.

In some examples, the priority component 745 may be configured as or otherwise support a means for transmitting, to the second UE, a message indicating a priority level associated with the one or more sidelink messages, the priority level corresponding to the threshold RSRP.

In some examples, the threshold RSRP is a pre-configured threshold at the first UE and the second UE, configured by a network, common to the first UE and the second UE, or a combination thereof.

In some examples, the preference of the second UE is based on whether a priority level associated with the sidelink resource satisfies a priority threshold associated with the set of sidelink resources.

In some examples, the priority threshold is a pre-configured priority threshold at the first UE and the second UE, configured by a network, common to the first UE and the second UE, or a combination thereof.

In some examples, the threshold component 750 may be configured as or otherwise support a means for transmitting, to the second UE, an indication of the priority threshold for generating the bitmap.

In some examples, the coordination message includes a set of bitmaps including the bitmap, each bitmap of the set of bitmaps corresponding to a respective priority threshold of a set of priority thresholds.

In some examples, the coordination message further includes a first indication of a priority threshold used to generate the bitmap, a second indication of a threshold RSRP used to generate the bitmap, a third indication of whether the preference of the second UE is associated with a preferred sidelink resource or a non-preferred sidelink resource, or a combination thereof.

In some examples, each bit of the bitmap corresponds to a respective sidelink resource of the set of sidelink resources. In some examples, each bit indicates a respective preference of the second UE for the respective sidelink resource. In some examples, the coordination message includes an SCI message, a MAC-CE message, an RRC message, or a combination thereof.

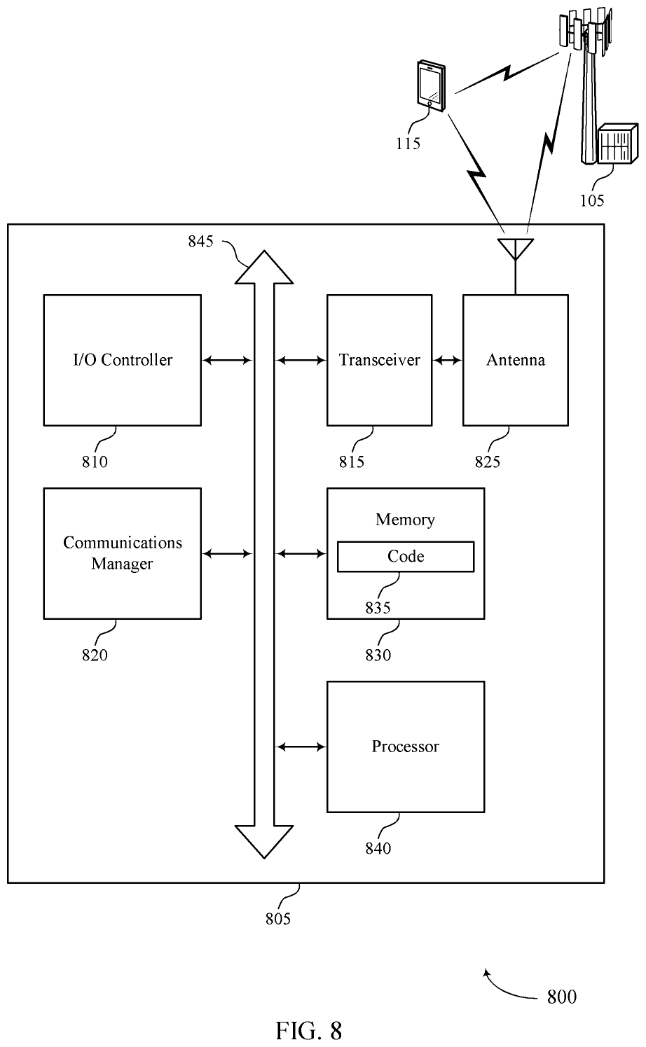

FIG. 8 shows a diagram of a system 800 including a device 805 that supports techniques for sidelink UE coordination in accordance with aspects of the present disclosure. The device 805 may be an example of or include the components of a device 505, a device 605, or a UE 115 as described herein. The device 805 may communicate wirelessly with one or more base stations 105, UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840). In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting techniques for sidelink UE coordination). For example, the device 805 or a component of the device 805 may include a processor 840 and memory 830 coupled to the processor 840, the processor 840 and memory 830 configured to perform various functions described herein.

The communications manager 820 may support wireless communication at a first UE in accordance with examples as disclosed herein. For example, the communications manager 820 may be configured as or otherwise support a means for monitoring a first set of sidelink resources for SCI from one or more UEs. The communications manager 820 may be configured as or otherwise support a means for generating, based on the monitoring, a bitmap associated with a second set of sidelink resources, where the bitmap indicates a preference of the first UE for a sidelink resource of the second set of sidelink resources. The communications manager 820 may be configured as or otherwise support a means for transmitting, to a second UE, a coordination message including the bitmap.

Additionally, or alternatively, the communications manager 820 may support wireless communication at a first UE in accordance with examples as disclosed herein. For example, the communications manager 820 may be configured as or otherwise support a means for receiving, from a second UE, a coordination message including a bitmap associated with a set of sidelink resources, where the bitmap indicates a preference of the second UE for a sidelink resource of the set of sidelink resources. The communications manager 820 may be configured as or otherwise support a means for transmitting, to the second UE, one or more sidelink messages using one or more sidelink resources of the set of sidelink resources, where the one or more sidelink resources are based on the preference of the second UE for the sidelink resource indicated by the bitmap.

By including or configuring the communications manager 820 in accordance with examples as described herein, the device 805 may support techniques for improved reliability, latency, resource utilization, power consumption, data rates, user experience related to reduced processing, coordination between devices, spectral efficiency, battery life, and processing capability, among other benefits.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of techniques for sidelink UE coordination as described herein, or the processor 840 and the memory 830 may be otherwise configured to perform or support such operations.

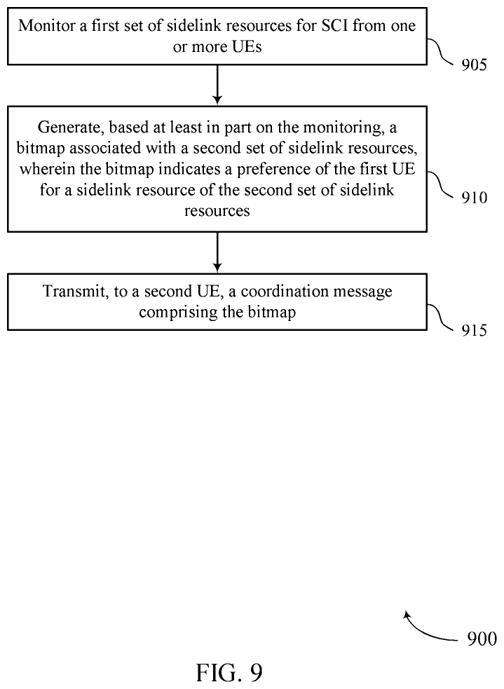

FIG. 9 shows a flowchart illustrating a method 900 that supports techniques for sidelink UE coordination in accordance with aspects of the present disclosure. The operations of the method 900 may be implemented by a first UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include monitoring a first set of sidelink resources for SCI from one or more UEs. The operations of 905 may be performed in accordance with examples as disclosed herein. In some examples, aspects of the operations of 905 may be performed by a control component 725 as described with reference to FIG. 7.

At 910, the method may include generating, based on the monitoring, a bitmap associated with a second set of sidelink resources, where the bitmap indicates a preference of the first UE for a sidelink resource of the second set of sidelink resources. The operations of 910 may be performed in accordance with examples as disclosed herein. In some examples, aspects of the operations of 910 may be performed by a preference component 730 as described with reference to FIG. 7.

At 915, the method may include transmitting, to a second UE, a coordination message including the bitmap. The operations of 915 may be performed in accordance with examples as disclosed herein. In some examples, aspects of the operations of 915 may be performed by a coordination component 735 as described with reference to FIG. 7.

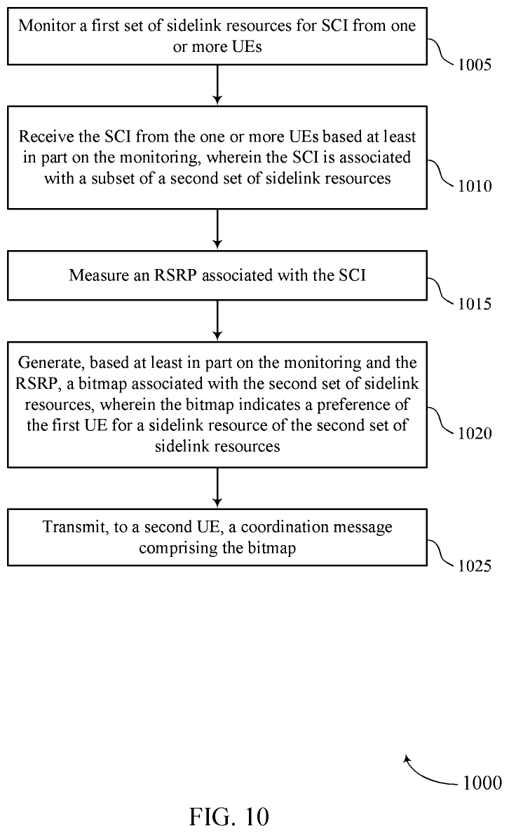

FIG. 10 shows a flowchart illustrating a method 1000 that supports techniques for sidelink UE coordination in accordance with aspects of the present disclosure. The operations of the method 1000 may be implemented by a first UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include monitoring a first set of sidelink resources for SCI from one or more UEs. The operations of 1005 may be performed in accordance with examples as disclosed herein. In some examples, aspects of the operations of 1005 may be performed by a control component 725 as described with reference to FIG. 7.

At 1010, the method may include receiving the SCI from the one or more UEs based on the monitoring, where the SCI is associated with a subset of a second set of sidelink resources. The operations of 1010 may be performed in accordance with examples as disclosed herein. In some examples, aspects of the operations of 1010 may be performed by a control component 725 as described with reference to FIG. 7.

At 1015, the method may include measuring an RSRP associated with the SCI. The operations of 1015 may be performed in accordance with examples as disclosed herein. In some examples, aspects of the operations of 1015 may be performed by a control component 725 as described with reference to FIG. 7.

At 1020, the method may include generating, based on the monitoring and the RSRP, a bitmap associated with the second set of sidelink resources, where the bitmap indicates a preference of the first UE for a sidelink resource of the second set of sidelink resources. The operations of 1020 may be performed in accordance with examples as disclosed herein. In some examples, aspects of the operations of 1020 may be performed by a preference component 730 as described with reference to FIG. 7.

At 1025, the method may include transmitting, to a second UE, a coordination message including the bitmap. The operations of 1025 may be performed in accordance with examples as disclosed herein. In some examples, aspects of the operations of 1025 may be performed by a coordination component 735 as described with reference to FIG. 7.

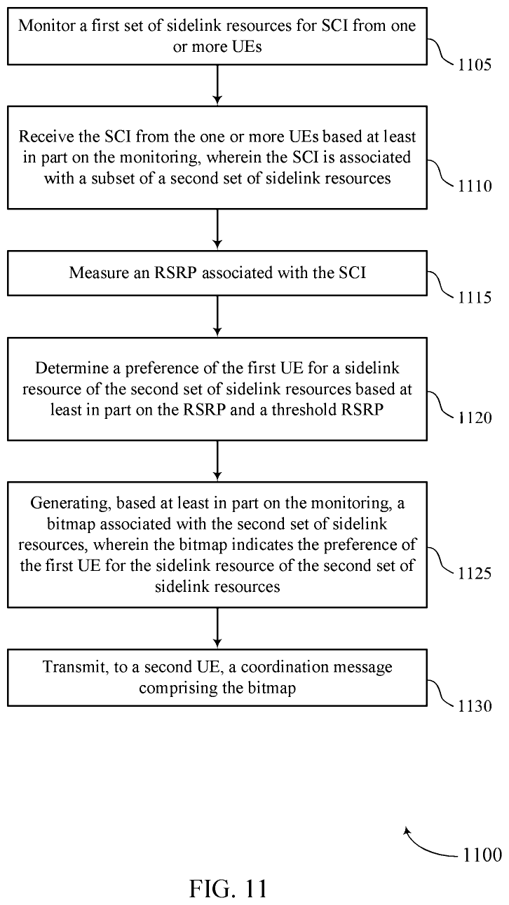

FIG. 11 shows a flowchart illustrating a method 1100 that supports techniques for sidelink UE coordination in accordance with aspects of the present disclosure. The operations of the method 1100 may be implemented by a first UE or its components as described herein. For example, the operations of the method 1100 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1105, the method may include monitoring a first set of sidelink resources for SCI from one or more UEs. The operations of 1105 may be performed in accordance with examples as disclosed herein. In some examples, aspects of the operations of 1105 may be performed by a control component 725 as described with reference to FIG. 7.

At 1110, the method may include receiving the SCI from the one or more UEs based on the monitoring, where the SCI is associated with a subset of a second set of sidelink resources. The operations of 1110 may be performed in accordance with examples as disclosed herein. In some examples, aspects of the operations of 1110 may be performed by a control component 725 as described with reference to FIG. 7.

At 1115, the method may include measuring an RSRP associated with the SCI. The operations of 1115 may be performed in accordance with examples as disclosed herein. In some examples, aspects of the operations of 1115 may be performed by a control component 725 as described with reference to FIG. 7.

At 1120, the method may include determining a preference of the first UE for a sidelink resource of the second set of sidelink resources based on the RSRP and a threshold RSRP. The operations of 1120 may be performed in accordance with examples as disclosed herein. In some examples, aspects of the operations of 1120 may be performed by a preference component 730 as described with reference to FIG. 7.

At 1125, the method may include generating, based on the monitoring, a bitmap associated with the second set of sidelink resources, where the bitmap indicates the preference of the first UE for the sidelink resource of the second set of sidelink resources. The operations of 1125 may be performed in accordance with examples as disclosed herein. In some examples, aspects of the operations of 1125 may be performed by a preference component 730 as described with reference to FIG. 7.

At 1130, the method may include transmitting, to a second UE, a coordination message including the bitmap. The operations of 1130 may be performed in accordance with examples as disclosed herein. In some examples, aspects of the operations of 1130 may be performed by a coordination component 735 as described with reference to FIG. 7.

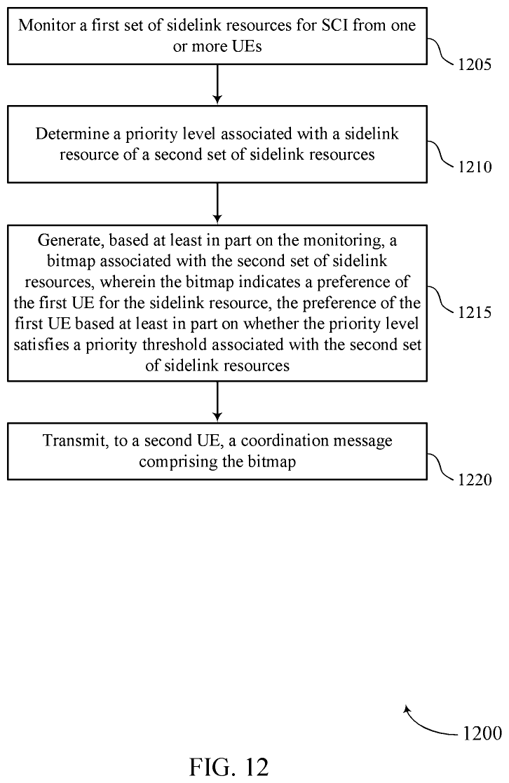

FIG. 12 shows a flowchart illustrating a method 1200 that supports techniques for sidelink UE coordination in accordance with aspects of the present disclosure. The operations of the method 1200 may be implemented by a first UE or its components as described herein. For example, the operations of the method 1200 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1205, the method may include monitoring a first set of sidelink resources for SCI from one or more UEs. The operations of 1205 may be performed in accordance with examples as disclosed herein. In some examples, aspects of the operations of 1205 may be performed by a control component 725 as described with reference to FIG. 7.

At 1210, the method may include determining a priority level associated with a sidelink resource of a second set of sidelink resources. The operations of 1210 may be performed in accordance with examples as disclosed herein. In some examples, aspects of the operations of 1210 may be performed by a priority component 745 as described with reference to FIG. 7.

At 1215, the method may include generating, based on the monitoring, a bitmap associated with the second set of sidelink resources, where the bitmap indicates a preference of the first UE for the sidelink resource, the preference of the first UE based on whether the priority level satisfies a priority threshold associated with the second set of sidelink resources. The operations of 1215 may be performed in accordance with examples as disclosed herein. In some examples, aspects of the operations of 1215 may be performed by a preference component 730 as described with reference to FIG. 7.

At 1220, the method may include transmitting, to a second UE, a coordination message including the bitmap. The operations of 1220 may be performed in accordance with examples as disclosed herein. In some examples, aspects of the operations of 1220 may be performed by a coordination component 735 as described with reference to FIG. 7.

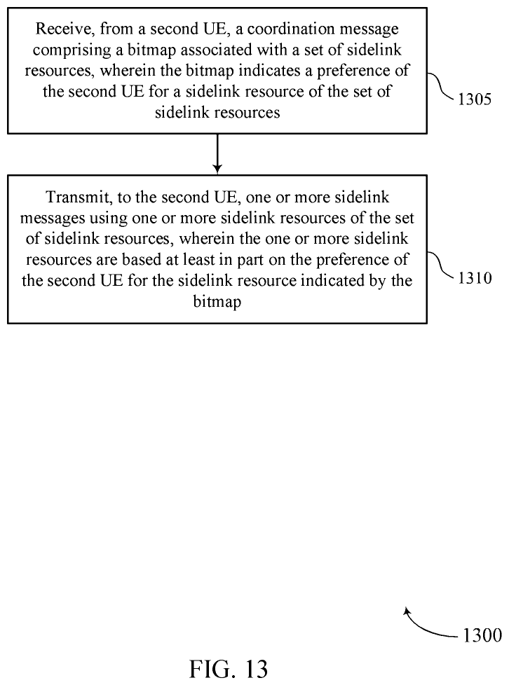

FIG. 13 shows a flowchart illustrating a method 1300 that supports techniques for sidelink UE coordination in accordance with aspects of the present disclosure. The operations of the method 1300 may be implemented by a first UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving, from a second UE, a coordination message including a bitmap associated with a set of sidelink resources, where the bitmap indicates a preference of the second UE for a sidelink resource of the set of sidelink resources. The operations of 1305 may be performed in accordance with examples as disclosed herein. In some examples, aspects of the operations of 1305 may be performed by a coordination component 735 as described with reference to FIG. 7.

At 1310, the method may include transmitting, to the second UE, one or more sidelink messages using one or more sidelink resources of the set of sidelink resources, where the one or more sidelink resources are based on the preference of the second UE for the sidelink resource indicated by the bitmap. The operations of 1310 may be performed in accordance with examples as disclosed herein. In some examples, aspects of the operations of 1310 may be performed by a communication component 740 as described with reference to FIG. 7.

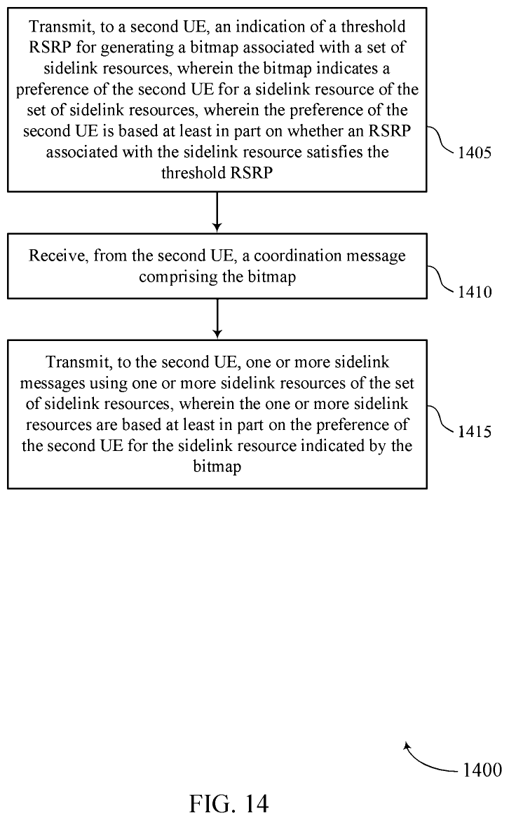

FIG. 14 shows a flowchart illustrating a method 1400 that supports techniques for sidelink UE coordination in accordance with aspects of the present disclosure. The operations of the method 1400 may be implemented by a first UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include transmitting, to a second UE, an indication of a threshold RSRP for generating a bitmap associated with a set of sidelink resources, where the bitmap indicates a preference of the second UE for a sidelink resource of the set of sidelink resources, where the preference of the second UE is based on whether an RSRP associated with the sidelink resource satisfies the threshold RSRP. The operations of 1405 may be performed in accordance with examples as disclosed herein. In some examples, aspects of the operations of 1405 may be performed by a threshold component 750 as described with reference to FIG. 7.

At 1410, the method may include receiving, from the second UE, a coordination message including the bitmap The operations of 1410 may be performed in accordance with examples as disclosed herein. In some examples, aspects of the operations of 1410 may be performed by a coordination component 735 as described with reference to FIG. 7.

At 1415, the method may include transmitting, to the second UE, one or more sidelink messages using one or more sidelink resources of the set of sidelink resources, where the one or more sidelink resources are based on the preference of the second UE for the sidelink resource indicated by the bitmap. The operations of 1415 may be performed in accordance with examples as disclosed herein. In some examples, aspects of the operations of 1415 may be performed by a communication component 740 as described with reference to FIG. 7.

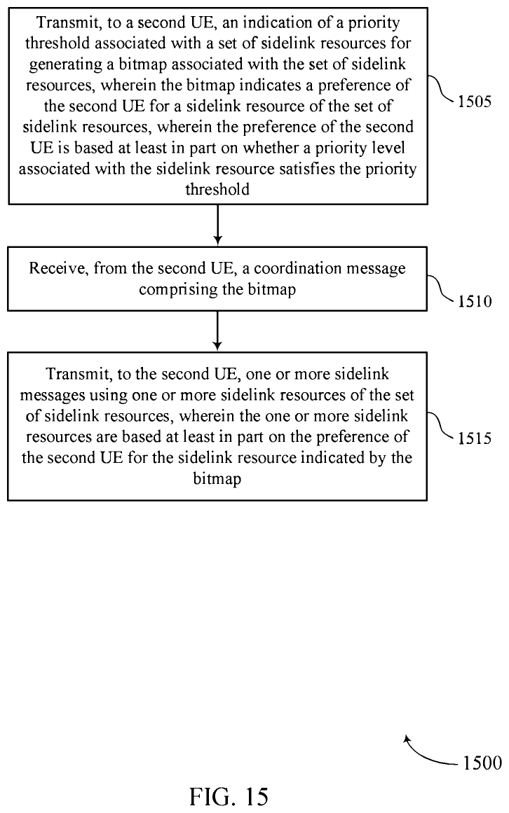

FIG. 15 shows a flowchart illustrating a method 1500 that supports techniques for sidelink UE coordination in accordance with aspects of the present disclosure. The operations of the method 1500 may be implemented by a first UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include transmitting, to a second UE, an indication of a priority threshold associated with a set of sidelink resources for generating a bitmap associated with the set of sidelink resources, where the bitmap indicates a preference of the second UE for a sidelink resource of the set of sidelink resources, where the preference of the second UE is based on whether a priority level associated with the sidelink resource satisfies the priority threshold. The operations of 1505 may be performed in accordance with examples as disclosed herein. In some examples, aspects of the operations of 1505 may be performed by a threshold component 750 as described with reference to FIG. 7.

At 1510, the method may include receiving, from the second UE, a coordination message including the bitmap. The operations of 1510 may be performed in accordance with examples as disclosed herein. In some examples, aspects of the operations of 1510 may be performed by a coordination component 735 as described with reference to FIG. 7.

At 1515, the method may include transmitting, to the second UE, one or more sidelink messages using one or more sidelink resources of the set of sidelink resources, where the one or more sidelink resources are based on the preference of the second UE for the sidelink resource indicated by the bitmap. The operations of 1515 may be performed in accordance with examples as disclosed herein. In some examples, aspects of the operations of 1515 may be performed by a communication component 740 as described with reference to FIG. 7.

The following provides an overview of aspects of the present disclosure:

Aspect 1: A method for wireless communication at a first UE, comprising: monitoring a first set of sidelink resources for SCI from one or more UEs: generating, based at least in part on the monitoring, a bitmap associated with a second set of sidelink resources, wherein the bitmap indicates a preference of the first UE for a sidelink resource of the second set of sidelink resources: and transmitting, to a second UE, a coordination message comprising the bitmap.

Aspect 2: The method of aspect 1, further comprising: receiving the SCI from the one or more UEs based at least in part on the monitoring, wherein the SCI is associated with a subset of the second set of sidelink resources: and measuring an RSRP associated with the SCI, wherein generating the bitmap is based at least in part on the RSRP.

Aspect 3: The method of aspect 2, further comprising: determining the preference of the first UE for the sidelink resource based at least in part on the RSRP and a threshold RSRP.

Aspect 4: The method of aspect 3, wherein the threshold RSRP is a pre-configured threshold at the first UE and the second UE, configured by a network, common to the first UE and the second UE, or a combination thereof.

Aspect 5: The method of aspect 3, further comprising: receiving, from the second UE, an indication of the threshold RSRP, wherein determining the preference of the first UE for the sidelink resource is based at least in part on the indication.

Aspect 6: The method of aspect 3, further comprising: determining a priority level associated with a transmission of the second UE associated with the second set of sidelink resources: and determining the threshold RSRP from a set of threshold RSRPs corresponding to a set of priority levels comprising the priority level, the threshold RSRP corresponding to the priority level.

Aspect 7: The method of aspect 3, further comprising: determining the threshold RSRP such that an RSRP associated with at least a threshold percentage of the second set of sidelink resources satisfy the threshold RSRP.

Aspect 8: The method of any of aspects 1 through 7, further comprising: determining a priority level associated with the sidelink resource of the second set of sidelink resources, wherein the preference of the first UE for the sidelink resource is based at least in part on whether the priority level satisfies a priority threshold associated with the second set of sidelink resources.

Aspect 9: The method of aspect 8, wherein the priority threshold is a pre-configured priority threshold at the first UE and the second UE, configured by a network, common to the first UE and the second UE, or a combination thereof.

Aspect 10: The method of aspect 8, further comprising: receiving, from the second UE, an indication of the priority threshold associated with the second set of sidelink resources, wherein determining the priority level is based at least in part on the indication of the priority threshold.

Aspect 11: The method of aspect 8, further comprising: determining the priority threshold such that a priority level corresponding to a threshold percentage of the second set of sidelink resources satisfy the priority threshold.

Aspect 12: The method of any of aspects 1 through 11, further comprising: generating a set of bitmaps associated with the second set of sidelink resources, each bitmap of the set of bitmaps corresponding to a respective priority threshold of a set of priority thresholds, wherein the coordination message comprises the set of bitmaps.

Aspect 13: The method of any of aspects 1 through 12, wherein the coordination message further comprises a first indication of a priority threshold used to generate the bitmap, a second indication of a threshold RSRP used to generate the bitmap, a third indication of whether the preference of the first UE is associated with a preferred sidelink resource or a non-preferred sidelink resource, or a combination thereof.

Aspect 14: The method of any of aspects 1 through 13, wherein each bit of the bitmap corresponds to a respective sidelink resource of the second set of sidelink resources: each bit indicates a respective preference of the first UE for the respective sidelink resource: and the coordination message comprises an SCI message, a MAC-CE message, an RRC message, or a combination thereof.

Aspect 15: The method of any of aspects 1 through 14, further comprising: receiving, from the second UE, one or more sidelink messages using one or more sidelink resources of the second set of sidelink resources, the one or more sidelink resources based at least in part on the preference of the first UE for the sidelink resources indicated by the bitmap.

Aspect 16: A method for wireless communication at a first UE, comprising: receiving, from a second UE, a coordination message comprising a bitmap associated with a set of sidelink resources, wherein the bitmap indicates a preference of the second UE for a sidelink resource of the set of sidelink resources; and transmitting, to the second UE, one or more sidelink messages using one or more sidelink resources of the set of sidelink resources, wherein the one or more sidelink resources are based at least in part on the preference of the second UE for the sidelink resource indicated by the bitmap.

Aspect 17: The method of aspect 16, wherein the preference of the second UE is based at least in part on whether an RSRP associated with the sidelink resource satisfies a threshold RSRP.

Aspect 18: The method of aspect 17, further comprising: transmitting, to the second UE, an indication of the threshold RSRP for generating the bitmap.

Aspect 19: The method of aspect 17, further comprising: transmitting, to the second UE, a message indicating a priority level associated with the one or more sidelink messages, the priority level corresponding to the threshold RSRP.

Aspect 20: The method of aspect 17, wherein the threshold RSRP is a pre-configured threshold at the first UE and the second UE, configured by a network, common to the first UE and the second UE, or a combination thereof.

Aspect 21: The method of any of aspects 16 through 20, wherein the preference of the second UE is based at least in part on whether a priority level associated with the sidelink resource satisfies a priority threshold associated with the set of sidelink resources.

Aspect 22: The method of aspect 21, wherein the priority threshold is a pre-configured priority threshold at the first UE and the second UE, configured by a network, common to the first UE and the second UE, or a combination thereof.

Aspect 23: The method of aspect 21, further comprising: transmitting, to the second UE, an indication of the priority threshold for generating the bitmap.

Aspect 24: The method of any of aspects 16 through 23, wherein the coordination message comprises a set of bitmaps including the bitmap, each bitmap of the set of bitmaps corresponding to a respective priority threshold of a set of priority thresholds.

Aspect 25: The method of any of aspects 16 through 24, wherein the coordination message further comprises a first indication of a priority threshold used to generate the bitmap, a second indication of a threshold RSRP used to generate the bitmap, a third indication of whether the preference of the second UE is associated with a preferred sidelink resource or a non-preferred sidelink resource, or a combination thereof.

Aspect 26: The method of any of aspects 16 through 25, wherein each bit of the bitmap corresponds to a respective sidelink resource of the set of sidelink resources: each bit indicates a respective preference of the second UE for the respective sidelink resource: and the coordination message comprises an SCI message, a MAC-CE message, an RRC message, or a combination thereof.

Aspect 27: An apparatus for wireless communication at a first UE, comprising a processor: memory coupled with the processor: and instructions stored in the memory and executable by the processor to cause the apparatus to perform a method of any of aspects 1 through 15.

Aspect 28: An apparatus for wireless communication at a first UE, comprising at least one means for performing a method of any of aspects 1 through 15.

Aspect 29: A non-transitory computer-readable medium storing code for wireless communication at a first UE, the code comprising instructions executable by a processor to perform a method of any of aspects 1 through 15.

Aspect 30: An apparatus for wireless communication at a first UE, comprising a processor: memory coupled with the processor: and instructions stored in the memory and executable by the processor to cause the apparatus to perform a method of any of aspects 16 through 26.

Aspect 31: An apparatus for wireless communication at a first UE, comprising at least one means for performing a method of any of aspects 16 through 26.

Aspect 32: A non-transitory computer-readable medium storing code for wireless communication at a first UE, the code comprising instructions executable by a processor to perform a method of any of aspects 16 through 26.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a first user equipment (UE), comprising:
monitoring a first set of sidelink resources for sidelink control information from one or more UEs;
generating, based at least in part on the monitoring, a bitmap associated with a second set of sidelink resources, wherein the bitmap indicates a preference of the first UE for a sidelink resource of the second set of sidelink resources; and
transmitting, to a second UE, a coordination message comprising the bitmap.

2. The method of claim 1, further comprising:
receiving the sidelink control information from the one or more UEs based at least in part on the monitoring, wherein the sidelink control information is associated with a subset of the second set of sidelink resources; and
measuring a reference signal received power associated with the sidelink control information, wherein generating the bitmap is based at least in part on the reference signal received power.

3. The method of claim 2, further comprising:
determining the preference of the first UE for the sidelink resource based at least in part on the reference signal received power and a threshold reference signal received power.

4. The method of claim 3, wherein the threshold reference signal received power is a pre-configured threshold at the first UE and the second UE, configured by a network, common to the first UE and the second UE, or a combination thereof.

5. The method of claim 3, further comprising:
receiving, from the second UE, an indication of the threshold reference signal received power, wherein determining the preference of the first UE for the sidelink resource is based at least in part on the indication.

6. The method of claim 3, further comprising:
determining a priority level associated with a transmission of the second UE associated with the second set of sidelink resources; and
determining the threshold reference signal received power from a set of threshold reference signal received powers corresponding to a set of priority levels comprising the priority level, the threshold reference signal received power corresponding to the priority level.

7. The method of claim 3, further comprising:
determining the threshold reference signal received power such that a reference signal received power associated with at least a threshold percentage of the second set of sidelink resources satisfy the threshold reference signal received power.

8. The method of claim 1, further comprising:
determining a priority level associated with the sidelink resource of the second set of sidelink resources, wherein the preference of the first UE for the sidelink resource is based at least in part on whether the priority level satisfies a priority threshold associated with the second set of sidelink resources.

9. The method of claim 8, wherein the priority threshold is a pre-configured priority threshold at the first UE and the second UE, configured by a network, common to the first UE and the second UE, or a combination thereof.

10. The method of claim 8, further comprising:
receiving, from the second UE, an indication of the priority threshold associated with the second set of sidelink resources, wherein determining the priority level is based at least in part on the indication of the priority threshold.

11. The method of claim 8, further comprising:
determining the priority threshold such that a priority level corresponding to a threshold percentage of the second set of sidelink resources satisfy the priority threshold.

12. The method of claim 1, further comprising:
generating a set of bitmaps associated with the second set of sidelink resources, each bitmap of the set of bitmaps corresponding to a respective priority threshold of a set of priority thresholds, wherein the coordination message comprises the set of bitmaps.

13. The method of claim 1, wherein the coordination message further comprises a first indication of a priority threshold used to generate the bitmap, a second indication of a threshold reference signal received power used to generate the bitmap, a third indication of whether the preference of the first UE is associated with a preferred sidelink resource or a non-preferred sidelink resource, or a combination thereof.

14. The method of claim 1, wherein:
each bit of the bitmap corresponds to a respective sidelink resource of the second set of sidelink resources;
each bit indicates a respective preference of the first UE for the respective sidelink resource; and
the coordination message comprises a sidelink control information message, a medium access control-control element (MAC-CE) message, a radio resource control (RRC) message, or a combination thereof.

15. The method of claim 1, further comprising:
receiving, from the second UE, one or more sidelink messages using one or more sidelink resources of the second set of sidelink resources, the one or more sidelink resources based at least in part on the preference of the first UE for the sidelink resource indicated by the bitmap.

16. A method for wireless communication at a first user equipment (UE), comprising:
receiving, from a second UE, a coordination message comprising a bitmap associated with a set of sidelink resources, wherein the bitmap indicates a preference of the second UE for a sidelink resource of the set of sidelink resources; and
transmitting, to the second UE, one or more sidelink messages using one or more sidelink resources of the set of sidelink resources, wherein the one or more sidelink resources are based at least in part on the preference of the second UE for the sidelink resource indicated by the bitmap.

17. The method of claim 16, wherein the preference of the second UE is based at least in part on whether a reference signal received power associated with the sidelink resource satisfies a threshold reference signal received power.

18. The method of claim 17, further comprising:
transmitting, to the second UE, an indication of the threshold reference signal received power for generating the bitmap.

19. The method of claim 17, further comprising:
transmitting, to the second UE, a message indicating a priority level associated with the one or more sidelink messages, the priority level corresponding to the threshold reference signal received power.

20. The method of claim 17, wherein the threshold reference signal received power is a pre-configured threshold at the first UE and the second UE, configured by a network, common to the first UE and the second UE, or a combination thereof.

21. The method of claim 16, wherein the preference of the second UE is based at least in part on whether a priority level associated with the sidelink resource satisfies a priority threshold associated with the set of sidelink resources.

22. The method of claim 21, wherein the priority threshold is a pre-configured priority threshold at the first UE and the second UE, configured by a network, common to the first UE and the second UE, or a combination thereof.

23. The method of claim 21, further comprising:
transmitting, to the second UE, an indication of the priority threshold for generating the bitmap.

24. The method of claim 16, wherein the coordination message comprises a set of bitmaps including the bitmap, each bitmap of the set of bitmaps corresponding to a respective priority threshold of a set of priority thresholds.

25. The method of claim 16, wherein the coordination message further comprises a first indication of a priority threshold used to generate the bitmap, a second indication of a threshold reference signal received power used to generate the bitmap, a third indication of whether the preference of the second UE is associated with a preferred sidelink resource or a non-preferred sidelink resource, or a combination thereof.

26. The method of claim 16, wherein:
each bit of the bitmap corresponds to a respective sidelink resource of the set of sidelink resources;
each bit indicates a respective preference of the second UE for the respective sidelink resource; and
the coordination message comprises a sidelink control information message, a medium access control-control element (MAC-CE) message, a radio resource control (RRC) message, or a combination thereof.

27. An apparatus for wireless communication at a first user equipment (UE), comprising:
a processor;
memory coupled with the processor; and
instructions stored in the memory and executable by the processor to cause the apparatus to:
monitor a first set of sidelink resources for sidelink control information from one or more UEs;
generate, based at least in part on the monitoring, a bitmap associated with a second set of sidelink resources, wherein the bitmap indicates a preference of the first UE for a sidelink resource of the second set of sidelink resources; and
transmit, to a second UE, a coordination message comprising the bitmap.

28. The apparatus of claim 27, wherein the instructions are further executable by the processor to cause the apparatus to:
receive the sidelink control information from the one or more UEs based at least in part on the monitoring, wherein the sidelink control information is associated with a subset of the second set of sidelink resources; and
measure a reference signal received power associated with the sidelink control information, wherein generating the bitmap is based at least in part on the reference signal received power.

29. The apparatus of claim 27, wherein the instructions are further executable by the processor to cause the apparatus to:
determine a priority level associated with the sidelink resource of the second set of sidelink resources, wherein the preference of the first UE for the sidelink resource is based at least in part on whether the priority level satisfies a priority threshold associated with the second set of sidelink resources.

30. An apparatus for wireless communication at a first user equipment (UE), comprising:
a processor;
memory coupled with the processor; and
instructions stored in the memory and executable by the processor to cause the apparatus to:
receive, from a second UE, a coordination message comprising a bitmap associated with a set of sidelink resources, wherein the bitmap indicates a preference of the second UE for a sidelink resource of the set of sidelink resources; and
transmit, to the second UE, one or more sidelink messages using one or more sidelink resources of the set of sidelink resources, wherein the one or more sidelink resources are based at least in part on the preference of the second UE for the sidelink resource indicated by the bitmap.
